(19) United States
(12) Patent Application Publication
(10) Pub. No.: US 2006/0015414 A1
(43) Pub. Date: Jan. 19, 2006

(54) Container inventory management systems, methods and tools

(76) Inventors: Courtney B. Congram, Decatur, IL (US); Richard L. McClellan, Clinton, IL (US)

Correspondence Address: KIRKPATRICK & LOCKHART NICHOLSON GRAHAM LLP;HENRY W. OLIVER BUILDING, 535 SMITHFIELD STREET, PITTSBURGH, PA, 15222, US

(21) Appl. No.: 10/881,051

(22) Filed: Jun. 30, 2004

(51) Int. Cl. G06F 7/06

(52) U.S. Cl. 705/28

(57) ABSTRACT

An inventory management system configured for use in association with at least one container containing an amount of inventory material at a monitored location is provided. The system includes at least one measurement instrument operatively associated with the container, the measurement instrument being configured to generate at least one data signal representative of the amount of the inventory material in the container; a telemetry unit in communication with the measurement instrument, the telemetry unit being configured to receive at least the generated data signal from the measurement instrument and to convert the generated data signal into inventory information; a first server in communication with the telemetry unit via an Internet connection, the first server configured to receive at least the inventory information from the telemetry unit; and, at least a second server in communication with the first server, the second server configured for receiving at least the inventory information from the first server into at least one data storage medium operatively associated with the second server to process the inventory information for presentation on at least one website.

### BACKGROUND

Increasing customer satisfaction while reducing inventory costs is a goal universally strived for in business. To this end, many businesses such as manufacturers, retailers, and wholesalers have attempted to increase their competitive advantage by implementing lean manufacturing strategies that manage the inventory costs of direct and indirect (i.e., raw) material. For example, a company may implement just-in-time inventory systems, wherein a facility, such as a manufacturing plant, maintains a minimal inventory level that triggers suppliers to frequently replenish the inventory with deliveries that are synchronized with the plant's on-hand balances and actual and predicted material needs.

With many just-in-time inventory systems, material shipments may be triggered multiple times a day depending on the cost, size and use of the component or material. To avoid missed shipments that may result in material shortages or unwanted shipments that may result in excess inventory, companies monitor inventory data, such as material consumption rates, and compare this data against the on-hand balances of material located within a company's own facility. However, in an effort to reduce the total cost of a material supply system, it is also desirable for companies not only to track in-house material, but also to compile data that quantifies and describes the inventories located at their customers and/or suppliers and to communicate such data throughout the extended supply chain.

To communicate inventory information throughout the supply chain, conventional inventory systems employ communications equipment that typically require dedicated communication lines and/or complex networking infrastructures. Many conventional systems are often ineffective at communicating inventory information in an understandable and readily useable format. In addition, many businesses are either unwilling or unable to pay the cost of installing and maintaining the expensive, dedicated communications equipment associated with conventional systems for gathering inventory information.

What are needed, therefore, are enhanced systems, methods and tools for obtaining, processing, and/or managing data associated with inventory materials stored in containers.

### SUMMARY

In various embodiments of the present invention, an inventory management system configured for use in association with at least one container containing an amount of inventory material at a monitored location is provided. The system includes at least one measurement instrument operatively associated with the container, the measurement instrument being configured to generate at least one data signal representative of the amount of the inventory material in the container; a telemetry unit in communication with the measurement instrument, the telemetry unit being configured to receive at least the generated data signal from the measurement instrument and to convert the generated data signal into inventory information; a first server in communication with the telemetry unit via an Internet connection, the first server configured to receive at least the inventory information from the telemetry unit; and, at least a second server in communication with the first server, the second server configured for receiving at least the inventory information from the first server into at least one data storage medium operatively associated with the second server to process the inventory information for presentation on at least one website.

In various embodiments of the present invention, the inventory management system may include at least one of a monitoring mail server and an inventory management server, and/or at least one web server in operative association with at least one of the servers. In one aspect, the web server may be configured to display at least one customer summary screen including a product inventories section having for a customer at least one of a listing of products stored at the monitored location, a total inventory material amount associated with each product at the monitored location, and a listing of the monitored locations associated with the customer. In another aspect, the web server may be configured to display at least one location summary screen including for the monitored location a product inventory section having inventory material data displayed on a product-by-product basis for the containers at the monitored location.

In various embodiments of the present invention, an order processing system may be provided in operative association with the inventory management server. In one aspect, a payment processing system may be provided in operative association with at least one of the order processing system and a web server. The inventory management system may be configured to calculate whether an order for additional the inventory material should be placed for the monitored location. The order calculation may be based on at least one factor selected from the group consisting of a usage rate of the inventory material and a predetermined order point. The inventory management server may be configured for generating at least one notification in association with the inventory information. In one aspect of the invention, the inventory management server may be configured to generate an order automatically for additional inventory material. Order generation may be based on at least one factor selected from the group consisting of a calculated re-order point, a projected usage of the inventory material, a production schedule, and a historical usage rate for the inventory material.

Method and computer-readable media embodiments are also provided in association with embodiments of inventory management systems described herein.

### BRIEF DESCRIPTION OF DRAWINGS

Further advantages of the present invention may be understood by referring to the following description in association with the accompanying drawings, in which:

FIG. 1 is a schematic diagram of an inventory management system according to various embodiments of the present invention;

FIG. 1A is a schematic diagram of a measurement instrument according to various embodiments of the present invention;

FIG. 2 is a flowchart illustrating a process performed by the inventory management system depicted in FIG. 1 according to various embodiments of the present invention;

FIG. 3 is a schematic drawing of a web page according to various embodiments of the present invention;

FIG. 4 is an example of a web page screen display according to various embodiments of the present invention;

FIG. 5 is an example of a web page screen display according to various embodiments of the present invention;

FIG. 6 is an example of a web page screen display according to various embodiments of the present invention;

FIG. 7 is an example of a web page screen display according to various embodiments of the present invention;

FIG. 8 is an example of a web page screen display according to various embodiments of the present invention;

FIG. 9 is an example of a web page screen display according to various embodiments of the present invention;

FIG. 9A is an example of a web page screen display according to various embodiments of the present invention;

FIG. 10 is an example of a web page screen display according to various embodiments of the present invention;

FIG. 11 is a schematic diagram of an inventory management system according to various embodiments of the present invention;

FIG. 12 is an example of a web page screen display according to various embodiments of the present invention;

FIG. 13 is an example of a web page screen display according to various embodiments of the present invention;

FIG. 14 is an example of a web page screen display according to various embodiments of the present invention;

FIG. 15 is an example of a web page screen display according to various embodiments of the present invention;

FIG. 16 is an example of a web page screen display according to various embodiments of the present invention;

FIG. 17 is an example of a web page screen display according to various embodiments of the present invention;

FIG. 18 is an example of a web page screen display according to various embodiments of the present invention;

FIG. 19 is an example of a web page screen display according to various embodiments of the present invention;

FIG. 20 is an example of a web page screen display according to various embodiments of the present invention;

FIG. 21 is an example of a web page screen display according to various embodiments of the present invention;

FIG. 22 is an example of a web page screen display according to various embodiments of the present invention;

FIG. 23 is an example of an order notification according to various embodiments of the present invention;

FIG. 24 is an example of a web page screen display according to various embodiments of the present invention;

FIG. 25 is an example of a web page screen display according to various embodiments of the present invention; and,

FIG. 26 is an example of a web page screen display according to various embodiments of the present invention.

### DESCRIPTION

The term “communication” is used herein generally to refer to any wireless and/or wireline transmission and/or reception of data including, but not limited to, voice, text and video data. In addition, the terms “send,” “transmit” and “receive,” or any conjugations thereof, are used herein generally to refer to data communications over landline and/or wireless technologies including, but not limited to, point-to-point transfers and packet-switched networking.

The term “user” is used herein generally to refer to a person, apparatus, and/or operating system that interfaces and/or communicates with a device or system such as, for example, a person interfacing with an Internet accessible website or a Material Requirements Planning (“MRP”) system accessing and analyzing inventory information in a database and/or on a server.

The term “inventory information” is used herein generally to refer to data including, but not limited to, material identity, container level, inventory amount, inventory temperature, inventory flow rate, specific gravity of the material, moisture content of the material, inventory weight, container specifications, network specifications, user information, usage information, delivery information, monitoring location information and/or other specified parameters.

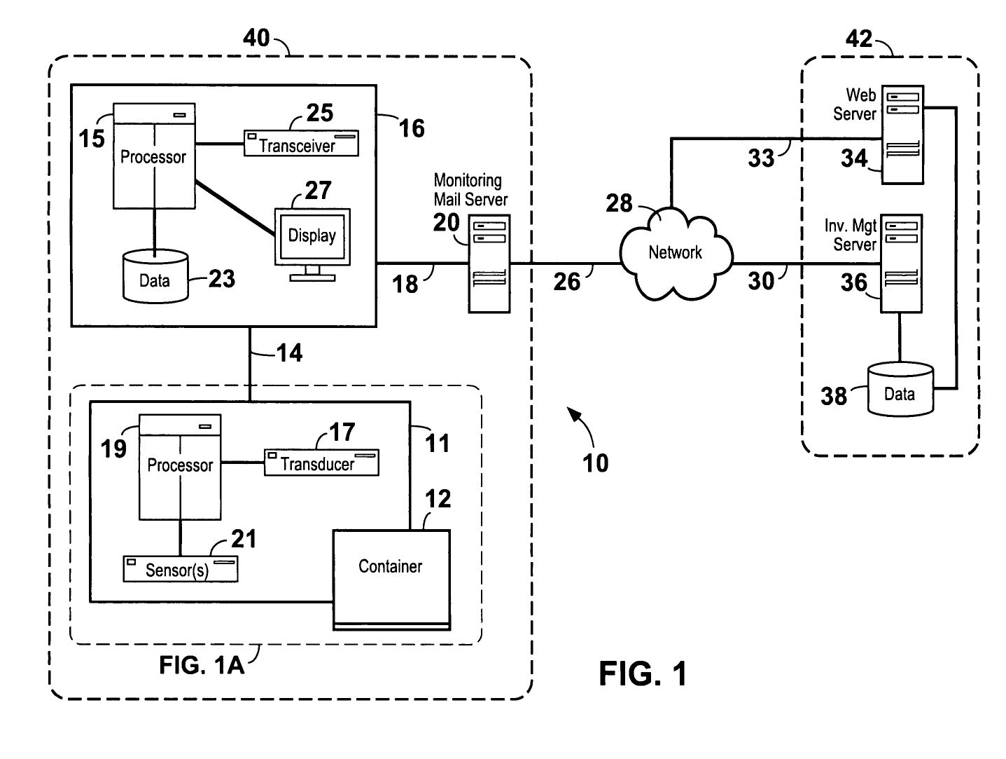

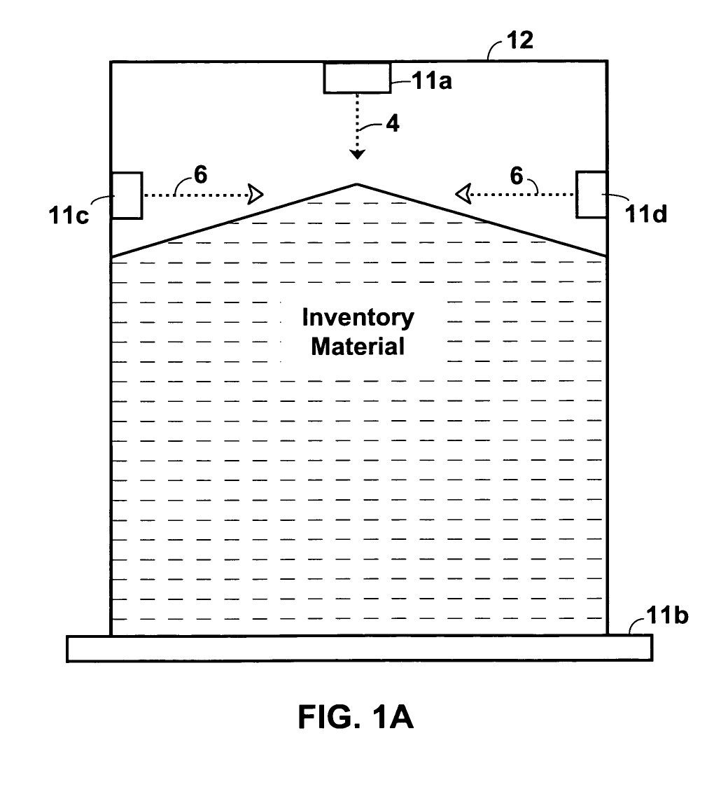

FIG. 1 is a block diagram of an inventory management system 10 structured in accordance with the present invention for monitoring and/or processing data associated with inventory material contained in one or more containers 12 at a monitored location 40. As applied herein, a “container” may include, for example and without limitation, a tank, bin, silo, cargo container, vessel and/or any other storage arrangement that may contain inventory material. According to various embodiments, “inventory material” may include, for example and without limitation, an amount or quantity of gas, liquid, fluid, dry materials, agricultural products (e.g., grain), food products (e.g., cereals), fabricated components (e.g., machined or stamped parts), hardware (e.g., screws, nuts, bolts), raw material and/or other types of physical goods.

In various embodiments of the present invention, the container 12 may be located at a monitored location 40 that comprises, for example and without limitation, a customer workplace, supplier workplace, storage facility, and/or a transportation vehicle, such as an aircraft or watercraft cargo hold, for example. In various aspects, a measurement instrument 11 may be operatively associated with the container 12 such as by attachment to external and/or internal surfaces of the container 12, for example. The measurement instrument 11 may include one or more operative components such as one or more sensors 21, for example, thermocouples, ultrasonic sensors, pressure sensors, sound sensors, radar sensors, strain gages and scales. The measurement instrument 11 may be calibrated to analyze the inventory material held in the container 12 by periodically or non-periodically generating and processing signals representative of the amount of inventory material in the container 12. In certain embodiments, data acquired from analysis of the inventory material may be acquired with a periodic cycle time such as, for example, on an hourly, daily, weekly, monthly or other suitable periodic basis.

A telemetry unit 16 may be operatively associated with the measurement instrument 11 and configured to receive data signals from the measurement instrument 11 representative of the amount of inventory material in the container 12. In various embodiments, the telemetry unit 16 may query the measurement instrument 11 to trigger the measurement instrument 11 to transmit data signals to the telemetry unit 16. The telemetry unit 16 may comprise a processor 15 that converts the transmitted signals into values and descriptions representing inventory information. In addition, the telemetry unit 16 may also store this information in a database 23.

As shown in FIG. 1A and to illustrate the above-mentioned embodiments, the measurement instrument 11 may operate substantially similarly to an ultrasonic level monitor 11a such as, for example, The Probe™, which is a sensor distributed by Siemens Milltroncis®. According to various embodiments, the measurement instrument 11a may comprise sensors 21 (e.g., temperature sensing elements), ultrasonic transducers 17, and/or other components configured to analyze inventory material in the container 12. In one operational example, the measurement instrument 11a such as, for example, The Probe™, measures a liquid level of an inventory material in the container 12. In this example, the measurement instrument 11a emits a series of ultrasonic pulses 4 from the transducer 17, wherein each pulse 4 is reflected as an echo from the liquid inventory material and sensed by the transducer 17. A processor 19 included within the measurement instrument 11 may be configured to analyze and filter the reflected pulse 4 to discriminate between a true echo reflected from the inventory material and false echoes generated by acoustical and electrical noises. In certain embodiments, the time for the pulse 4 to travel from the measurement instrument 11a to the inventory material and return back to the measurement instrument 11a may be temperature compensated and then converted into value signals capable of being relayed for further processing by other monitoring equipment. After the measurement instrument 11a generates and processes the ultrasonic echo signals 4, the telemetry unit 16 may query the measurement instrument 11a to trigger the measurement instrument 11a to transmit the value signals to the telemetry unit 16, wherein the telemetry unit 16 may convert the signals into inventory information. In another operational example, the measurement instrument 11 may, for example, operate substantially similarly to the PTX 1240™, which is an industrial pressure transmitter suitable for use in the oil and gas industry and distributed by Druck Incorporated™.

In various embodiments, the measurement instrument 11 may, for example, operate substantially similarly to a scale 11b. According to these embodiments, the scale 11b may be utilized to measure an amount of dry inventory material and may include an operative association with one or more springs and transducers 17 configured to analyze the weight of the inventory material in the container 12. In one embodiment, the transducers 17 may transmit a data signal representative of the weight of the inventory material to the telemetry unit 16, wherein the telemetry unit may convert the data signal into inventory information.

In certain embodiments, the measurement instrument 11 may also operate substantially similarly to one or more infrared sensors 11c. According to these embodiments, the infrared sensors 11c may be configured to analyze a defined level associated with the inventory material in the container 12 and transmit a data signal to the telemetry unit 16, wherein the telemetry unit 16 may convert the data signal into inventory information. In one operational example, the defined level may be measured from a bottom portion of the container 12 to a refill location at an elevation higher than the bottom portion of the container 12. In operation, a portion of the inventory material in the vicinity of the refill location interrupts an infrared beam 6 extending from the infrared sensor 11c to resist connection of an electrical circuit, for example, including the infrared sensor 11c. Upon depletion of the inventory material from the container, the portion of the inventory material in contact with the infrared sensor beam 6 may descend from the refill location toward the bottom portion of the container 12 and become out of contact with the infrared sensor beam 6. It can be seen that sufficient descent of the inventory material may result in the infrared beam 6 completing an electrical circuit within the infrared sensor 11c that, in turn, causes an electrical signal representative of the now depleted level of the inventory material within the container 12 to be communicated to the telemetry unit 16.

In various embodiments, the measurement instrument 11 may include one or more sensors configured to analyze the composition and/or other attributes of the inventory material. According to these embodiments, the measurement instrument 11 may transmit data signals representing the composite of the inventory material, wherein the transmission of such data is used to preserve the container 12 for use in containing only one type or certain types of inventory material. Such systems and devices may be useful for promoting identity preservation in industries such as, for example, agricultural products, food products, oil, gas, and/or other industries wherein preserving quality requirements, maintaining safety standards, and/or meeting other requirements for avoiding cross-contamination of different kinds of inventory material may be desired.

Referring again to FIG. 1 and to further illustrate various embodiments of the present invention, the telemetry unit 16 may be in data communication with a monitoring mail server 20. The telemetry unit 16 may further comprise a transceiver 25 configured to transmit inventory information and/or other data to the monitoring mail server 20 and/or receive inventory information or other data from the monitoring mail server 20. In addition, the telemetry unit 16 may be equipped with a display 27 that enables a user at the monitored location 40 to view data being monitored and communicated by the inventory management system 10.

In various embodiments, the monitoring mail server 20 may be configured to store data, transmit data and/or receive data through its operative association with the telemetry unit 16 and other servers within the inventory management system 10. The monitoring mail server 20 may also be configured to generate, transmit and receive notifications, wherein the notifications may include, for example and without limitation, (1) delivery notifications that detail a supplier's promise date to deliver material, (2) inventory level notifications that communicate potential material “stock-outs” and/or (3) system alerts that inform customers and suppliers of network outages, measurement instrument loss, hardware/software issues or other system failures.

According to the present embodiments, the telemetry unit 16 may be in communication with the measurement instrument 11 via a wireline and/or wireless communications link 14. In addition, the telemetry unit 16 may also be in communication with the monitoring mail server 20 via a wireline and/or wireless communications link 18. In certain embodiments, the communications links 14 and 18 may be a wireline connection such as, for example, an Ethernet connection or other conventional twisted pair copper wirelines or coaxial cable connection. In various aspects, the communications links 14 and 18 may also be implemented as a wireless connection. Wireless network connectivity between the measurement instrument 11 and the telemetry unit 16 (depicted as communications link 14), and wireless network connectivity between the telemetry unit 16 and the monitoring mail server 20 (depicted as communications link 18), may be accomplished using radio frequencies (RF) such as, for example, IEEE 802.11 wireless LAN or Bluetooth technologies. The IEEE 802.11 standard defines the protocol for two types of networks: ad hoc and client/server networks. An ad hoc network may be a network in which communications are established between multiple stations in a given coverage area without the use of an access point or server. The standard specifies the etiquette that each station must observe so that all stations have fair access to the wireless media. It provides methods for arbitrating requests to use the media to ensure that throughput is maximized for all stations in the base service set. The client/server network uses an access point that controls the allocation of transmit time for all stations and allows mobile stations to roam from cell to cell. The access point is used to handle traffic from the mobile radio to the wired or wireless backbone of the client/server network. This arrangement allows for point coordination of all of the stations in the basic service area and ensures proper handling of the data traffic. The access point also routes data to and from a network server and between wireless stations.

Bluetooth radio technology provides a universal bridge to existing data networks, a peripheral interface, and a mechanism to form small private ad hoc groupings of connected devices away from fixed network infrastructures. Designed to operate in an RF environment, the Bluetooth radio uses fast-acknowledgment and frequency-hopping schemes to make a link between a data network and a peripheral interface. In addition, Bluetooth radio modules may avoid interference from other signals by hopping to a new frequency after transmitting or receiving a data packet.

In various embodiments, the inventory management system 10 may be structured for interaction with a manual data collection system in addition to or in place of an automatic system of gathering inventory information (e.g., the telemetry unit 16 operatively associated with the measurement instrument 11). An operator, for example, may (1) observe the inventory material contained in the container 12, (2) record inventory information and/or other data on paper and/or a spreadsheet, and/or (3) manually input the inventory information and/or other data into the monitoring mail server 20.

According to various embodiments, the monitoring mail server 20 may be in communication with an inventory management server 36 via a network 28 such as, for example, the Internet. In addition, the inventory management server 36 may be located at an inventory management location 42, wherein the inventory management location 42 may include a customer workplace, supplier workplace, storage facility and/or transportation vehicle, aircraft or ship vessel. The servers 20, 36 may provide network addressing and routing, wherein the monitoring mail server 20 functions as a first gateway between the monitoring location 40 and the network 28 and the inventory management server 36 functions as a second gateway between the inventory management location 42 and the network 28. In certain embodiments, the servers 20, 36 may transfer and/or receive data through one or more email systems that are in communication with the network 28 via communications links 26 and 30 respectively, which may be TCP/IP (Transmission Control Protocol/Internet Protocol) connections, for example.

In various embodiments, the servers 20, 36 may also be configured to transmit and/or receive inventory information and/or other data via an Advanced Intelligent Network (“AIN”). The inventory information and/or other data may be formatted in a File Transfer Protocol (“FTP”), wherein the FTP may be employed when locations 40, 42 may not be able to access an email system and/or the Internet. In certain embodiments, the inventory management server 36 may be configured to receive data in the form of a Universal Datagram Packet (“UDP”). For example, the UDP may be employed to transfer tank readings internally within a company via a wireless Ethernet connection. In various aspects, the inventory management server 36 may be configured to transmit and receive inventory information and other data to/from the monitored location 40, wherein the monitored location 40 comprises any type of communication equipment such as, for example, a wireless or wireline microcomputer, minicomputer, laptop, personal data assistant (PDA), wireless e-mail device (e.g., BlackBerry), cellular phone, pager, processor, or any other programmable device or computer system configured to transmit and receive data over the network 28.

In certain embodiments, the inventory management server 36 may be configured to transmit data to and/or receive data from the monitoring mail server 20 and other servers operatively associated with the inventory management system 10. The inventory management server 36 may also be configured to generate, transmit and receive notifications, wherein the notifications may include, for example and without limitation, (1) delivery notifications that detail a supplier's promise date to deliver material, (2) inventory level notifications that communicate potential material “stock-outs” and/or (3) system alerts that inform customers and suppliers of network outages, measurement instrument loss, hardware/software issues or other system failures.

In various embodiments, the inventory management server 36 may be configured to extract data from a communication sent from the monitoring mail server 20 and store the data in a database 38, wherein the database 38 is in communication with a web server 34. In certain aspects of the invention, the inventory management server 36 may be operatively associated with the web server 34 in a single server. Once data is extracted and transferred to the database 38, the web server 34 may access and display the data on an Internet website that may be made accessible to users from the monitored location 40, the inventory management location 42, and/or another Internet-accessible location. As a data integrity check, the inventory management server 36 may verify the location of the monitoring mail server 20 by comparing the Internet protocol (“IP”) address of the monitoring mail server 20 against a registry including various monitored locations. If data is transmitted from an IP address that is not registered, the inventory management server 36 can be configured to not accept the data and thus not allow the information to be displayed by the inventory management system 10.

In certain aspects of the present invention, the web server 34 may be configured to transmit data to and/or receive data from the inventory management server 36 and the monitoring mail server 20 via the network 28. The web server 34 may be coupled to the network 28 by a communications link 33, which may be a TCP/IP (Transmission Control Protocol/Internet Protocol) connection, for example. In addition, the web server 34 may also be configured to generate, transmit and/or receive notifications, wherein the notifications may include, for example and without limitation, (1) delivery notifications that detail a supplier's promise date to deliver material, (2) inventory level notifications that communicate potential material “stock-outs” and/or (3) system alerts that inform customers and suppliers of network outages, measurement instrument loss, hardware/software issues or other system failures.

In various embodiments, at least one of the servers 20, 34, 36 may be based on Extensible Markup Language (“XML”), a computer language that encloses data in “documents” that are portable between/among software applications, wherein the data may include inventory information, notifications and/or other data utilized by the inventory management system 10. According to certain embodiments, XML may be utilized as a system-independent language for representing data that is transmitted across the network 28 and between/among the servers 20, 34, 36. This transmission of data may be in the form of simple object access protocol (“SOAP”) messages, which are XML-based messages that are communicated through standard Internet protocols such as, for example, Hypertext Transfer Protocol (“HTTP”) and Simple Mail Transfer Protocol (“SMTP”). In addition, communication of data through the measurement instrument 11, the telemetry unit 16 and/or the servers 20, 34, 36 may, for example, (1) occur at defined cycle times, (2) occur in real time and/or (3) be triggered by a customer and/or a supplier interacting with an Internet-accessible website that is supported by the web server 34.

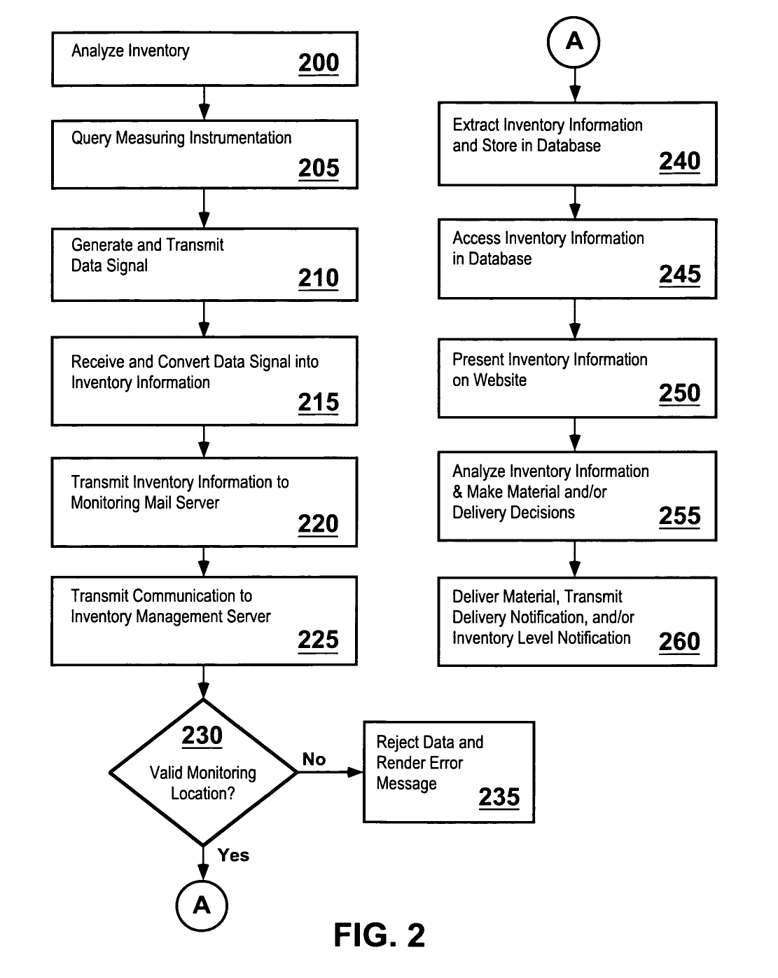

FIG. 2 is a flowchart illustrating embodiments of processes performed by the inventory management system 10 depicted in FIG. 1. At a predetermined time, the measurement instrument 11 analyzes the inventory material held in the container 12 as shown by step 200. In step 205, the telemetry unit 16 queries the measurement instrument 11, and in response to this query, the measurement instrument 11 generates and transmits value data signals to the telemetry unit 16 in step 210. At step 215, the telemetry unit 16 receives and converts the data signals into inventory information. The telemetry unit 16 then proceeds to transmit, at step 220, the inventory information to the monitoring mail server 20, which may be in communication with at least one of the inventory management server 36 and/or the web server 34 via the network 28.

At step 225, the monitoring mail server 20 transmits a communication comprising the inventory information to the inventory management server 36. The inventory management server 36 then determines if the monitoring mail server 20 is associated with a valid monitoring location 40 as shown by step 230. If the monitoring mail server 20 is not associated with a valid monitoring location 40, the inventory management server 36 rejects the data and renders an error message at step 235. However, if the monitoring mail server 20 is associated with a valid monitoring location 40, the inventory management server 36 extracts inventory information from the communication and stores the inventory information in the database 38 as shown by step 240. At step 245, the web server 34 accesses the inventory information in the database 38, and at step 250, presents the inventory information on an Internet-accessible website that is viewable by a user of the inventory management system 10.

The process may then proceed to step 255 where the user such as, for example, an operator and/or an MRP system, may analyze the inventory information and consider a variety of inventory material management decisions. Examples of such management decisions may include, for example, determining whether the quality of the monitored material is acceptable and/or making delivery decisions based on the amount of inventory material contained in the container 12 in relation to a predetermined re-order quantity. In various aspects, the re-order quantity may be based on: (1) the amount of inventory contained in the container 12, (2) the projected/forecasted use of the inventory material, and/or (3) the lead-time required to replenish the inventory. At step 260, in accordance with various operational examples described herein, the user may cause the inventory management system 10 to deliver a shipment of material, transmit a delivery notification that details a supplier's promise date to deliver material and/or transmit an inventory level notification that communicates a potential material “stock-out.”

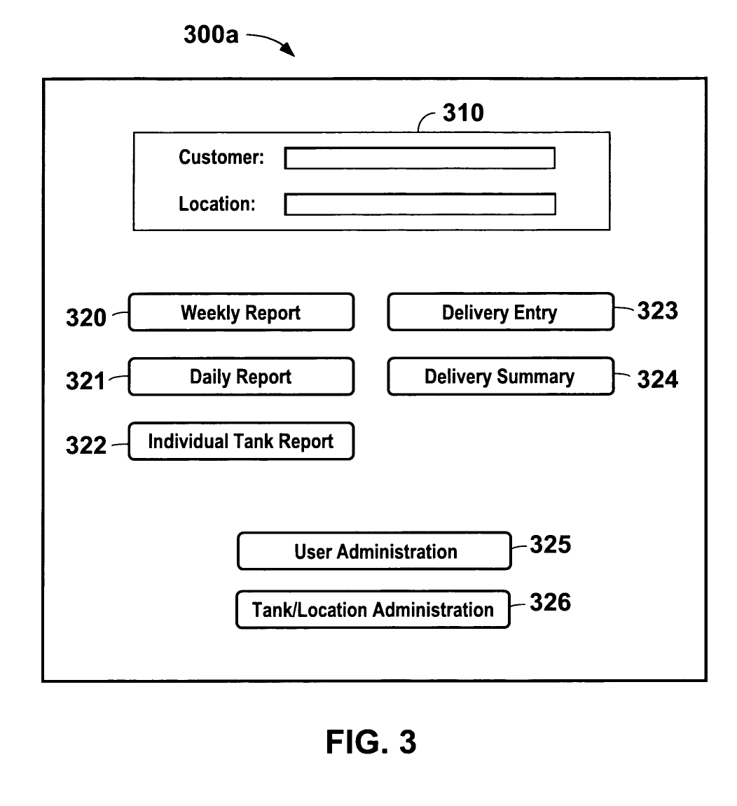

FIGS. 3 through 10 illustrate various examples of web page screen displays according to various embodiments of the present invention, wherein the web pages are supported by the web server 34, for example, and may be Internet-accessible such as through the network 28. The web server 34 may support a website that comprises one or more graphical user interfaces (GUIs) configured to receive and display user inputs and data as shown by web pages 300a-300i.

FIG. 3 illustrates a schematic representation of a web page 300a that may function as a main menu screen that enables customers and suppliers, for example, to organize, view and input data regarding the inventory management system 10. In certain embodiments, the web page 300a may allow a user to input customer and monitored location 40 information. The customer and monitored location 40 input may cause the web server 34 to execute a program comprising a set of exclusionary rules that enable or disable data and/or tabs based on the customer and location input.

In various embodiments, the web page 300a may also function as a security screen that requires users of the inventory management system 10 to enter a valid username and password in area 310 of the web page 300a. Entering a username and password may cause the web server 34 to execute a program that compares the username and password entry against a user registry. If the username and password entry are not recorded in the registry, the web server 34 can be configured to not permit a login to occur.

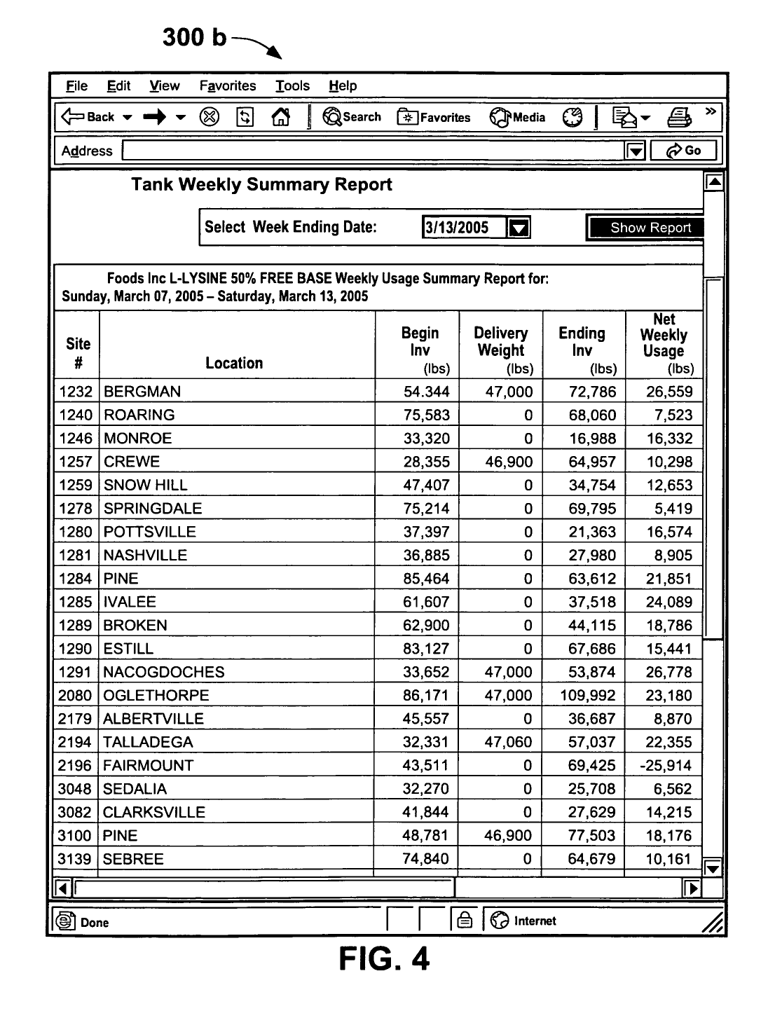

In certain embodiments, the web page 300a may also feature system tabs 320-326, which may be configured to connect from the web page 300a to various secondary web pages that display, for example, weekly reports (320), daily reports (321), individual tank reports (322), delivery entry (323), delivery summary (324), user administration (325) and tank/location administration (326). Each of these system tabs 320-326 and their corresponding secondary web pages are further described hereinbelow with reference to FIG. 4-FIG. 10.

Referring now to FIG. 4, a sample web page 300b that may be served when a user selects the “Weekly Report” tab 320 on the web page 300a shown in FIG. 3. The web page 300b may include a matrix report, wherein the report organizes the weekly usage of a particular product or inventory material according to each monitored location 40 that uses the inventory material and transmits weekly usage information to the web server 34. In various embodiments, the web page 300b may describe the weekly usage of a product per monitored location 40 by including data fields such as, for example, customer description, product description, site number, location description, beginning inventory (in pounds), delivery weight (in pounds), ending inventory (in pounds) and net weekly usage (in pounds). The web page 300b may also be configured to allow the user to input the “Week Ending Date,” for example, which defines a seven (7) day period of product usage that the user desires to view.

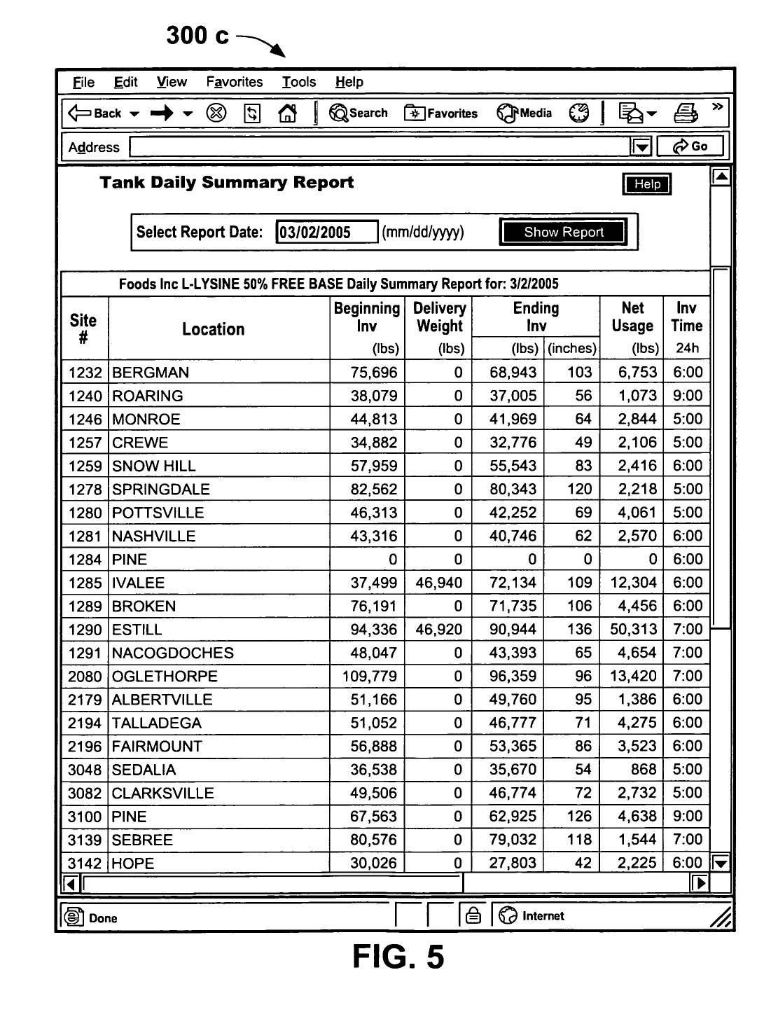

FIG. 5 illustrates an example of a web page 300c, provided in accordance with the present invention, which is served when a user selects the “Daily Report” tab 321 on the web page 300a shown in FIG. 3. In various embodiments, the web page 300c may include a matrix report, wherein the report organizes the daily usage of a particular product or inventory material according to each monitored location 40 that uses the product and transmits daily usage information to the web server 34. In certain embodiments, the web page 300c may describe the daily usage of a product per monitored location 40 by including data fields such as, for example, customer description, product description, site number, location description, beginning inventory (in pounds), delivery weight (in pounds), ending inventory (in pounds and inches), net daily usage (in pounds), and the time of day that the information was recorded. In addition, the web page 300c may also be configured to allow the user to input the “Report Date,” for example, which defines a twenty-four (24) hour period of product usage that the user desires to view.

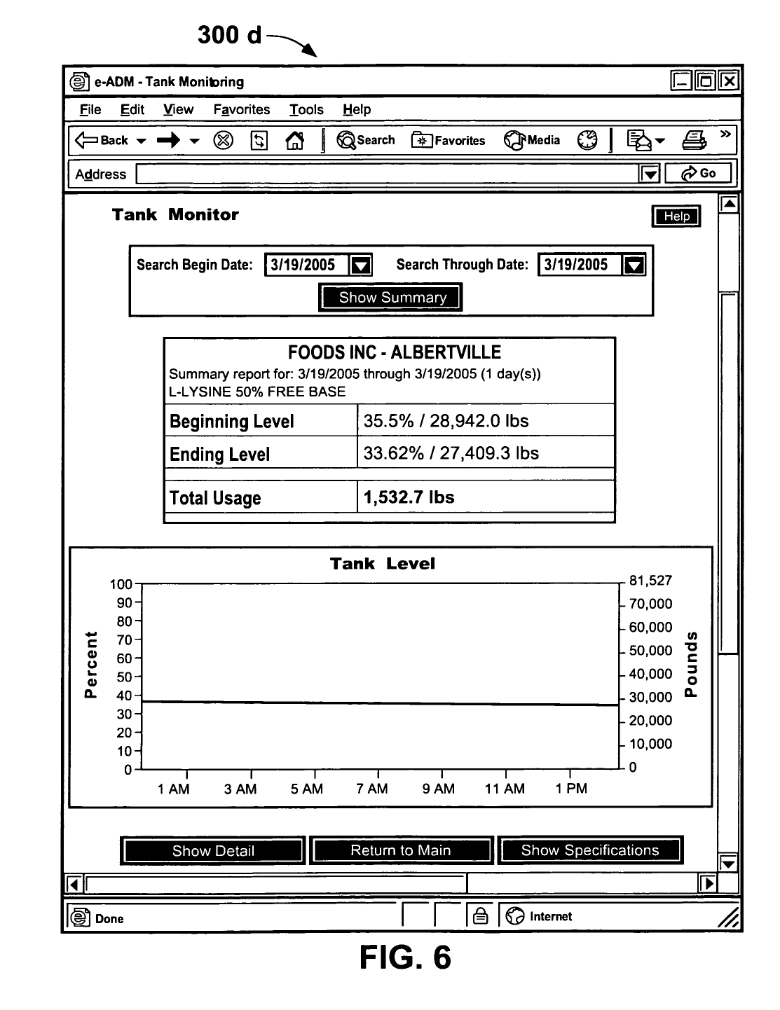

FIG. 6 illustrates an example of a web page 300d, according to embodiments of the present invention, which is served when a user selects the “Individual Tank Report” tab 322 on web page 300a shown in FIG. 3. The web page 300d may describe the usage of a particular product or inventory material in relation to each container 12 that holds the product (e.g., tank level). For example, the web page 300c may be configured to allow the user to input a “Search Begin Date” and/or a “Search Through Date,” which dates define a time period of product usage that the user desires to view. The web page 300d may also feature a graph that enables the user to quickly reference the “tank level” of a product over the user-defined time period. In certain embodiments, the web page 300d may also describe the product inventory level by displaying one or more of the following data fields: customer description, product description, site number, location description, beginning inventory (e.g., in pounds and in tank level percentage), delivery weight (e.g., in pounds and in tank level percentage), ending inventory (e.g., in pounds and in tank level percentage) and total usage (e.g., in pounds). The web page 300d may also include tabs that enable the user to access more detailed information concerning the container 12 and/or product inventory.

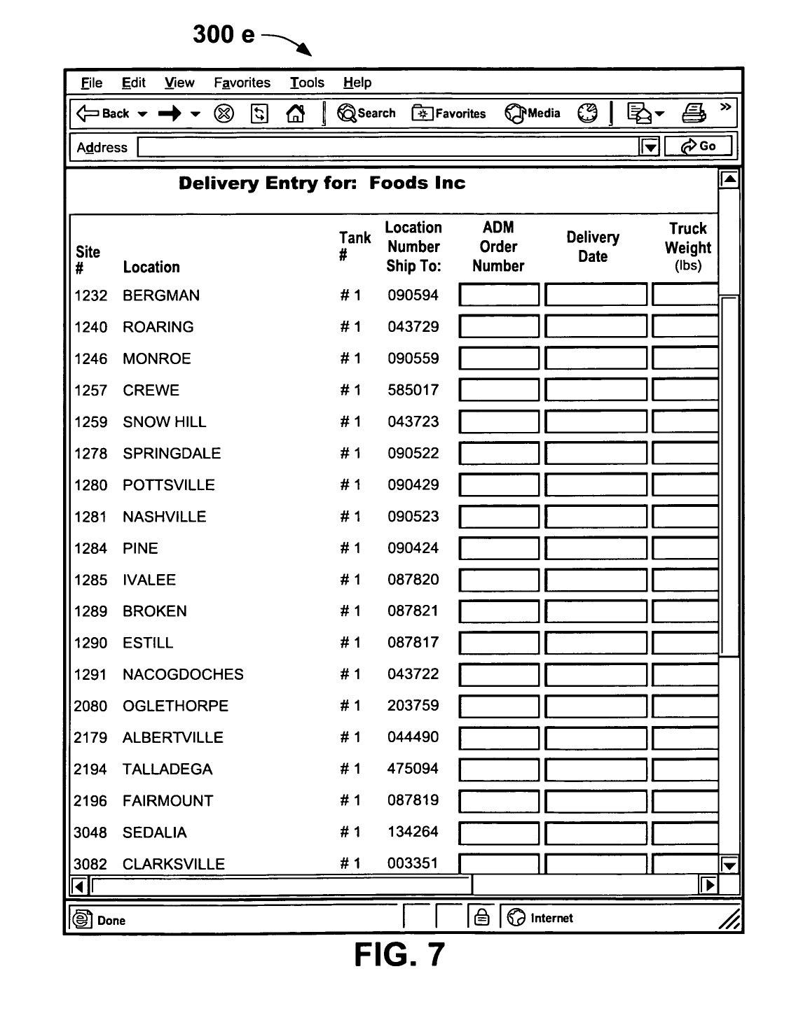

Referring now to FIG. 7, an example of a web page 300e in accordance with the present invention is shown. The web page 300e is served when a user selects the “Deliver Entry” tab 323 on the web page 300a shown in FIG. 3. In various embodiments, the web page 300e may enable the supplier to enter, edit and/or delete product delivery schedules for inventory material at one or more monitored locations 40. The web page 300e may enable a user to update a delivery schedule by displaying, for example, one or more of the following data fields: customer description, product description, site number, location description, tank number, location number to ship to, order number, delivery date and truck weight (in pounds). The web page 300e may be configured to accept updates to the product delivery schedule, wherein the updates are entered automatically by a supplier's order replenishment system. In certain embodiments, the web page 300e may alternatively be configured to accept updates to the product delivery schedule, wherein the updates are manually entered by users. Updates to a delivery schedule on the web page 300e may cause the web server 34 and/or the inventory management server 36 to e-mail, for example, a delivery notification to the monitoring mail server 20, thus informing the customer associated with the monitored location 40, for example, of an upcoming, modified and/or cancelled material shipment.

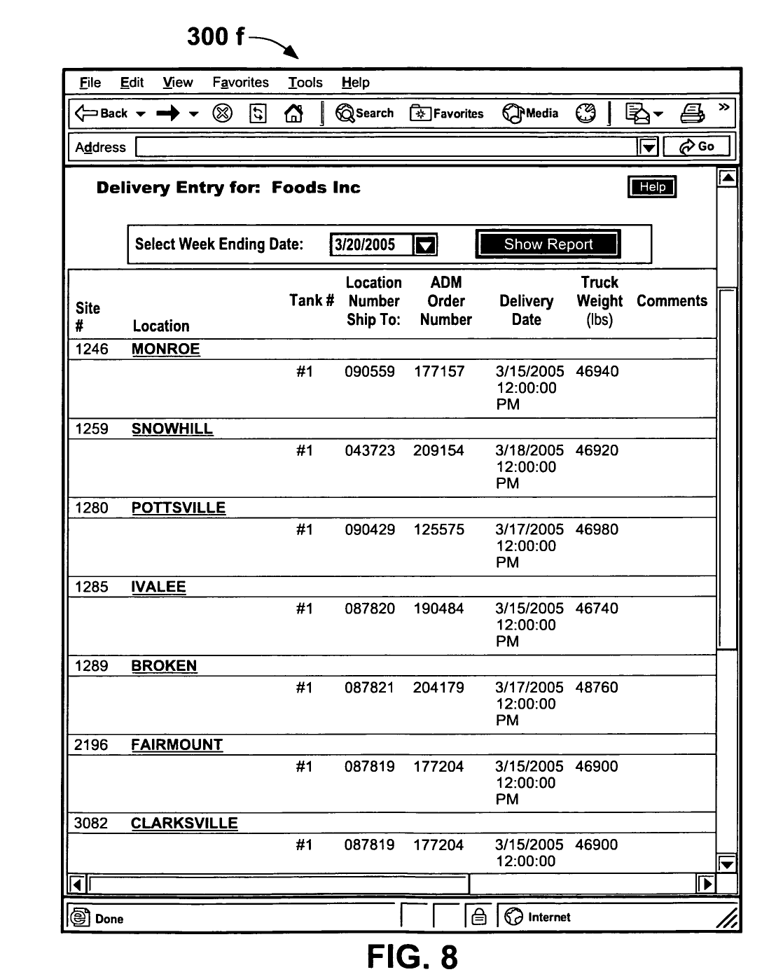

FIG. 8 illustrates an example web page 300f structured in accordance with various embodiments of the present invention. The web page 300f is served when a user selects the “Delivery Summary” tab 324 on web page 300a shown in FIG. 3. In various embodiments, the web page 300f may be configured to allow a user to input the “Week Ending Date,” for example, which defines a seven (7) day period of delivery schedules that the user desires to view. The web page 300f may include a report that displays a weekly list of shipments for a particular product or inventory material, wherein the shipments are designated to arrive at one or more monitored locations 40 within the user-defined time period. In certain embodiments, the web page 300f may also describe the scheduled weekly shipments of a product per monitored location 40 by including data fields such as, for example, customer description, product description, site number, location description, tank number, location number to ship to, order number, delivery date, truck weight (in pounds) and comments.

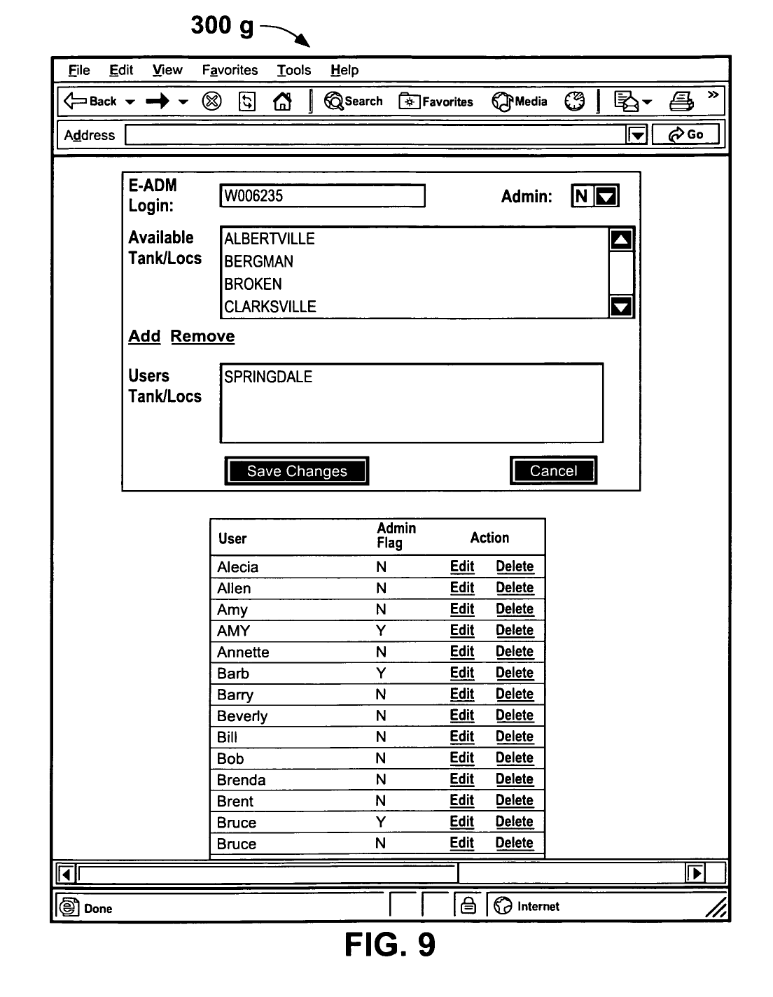

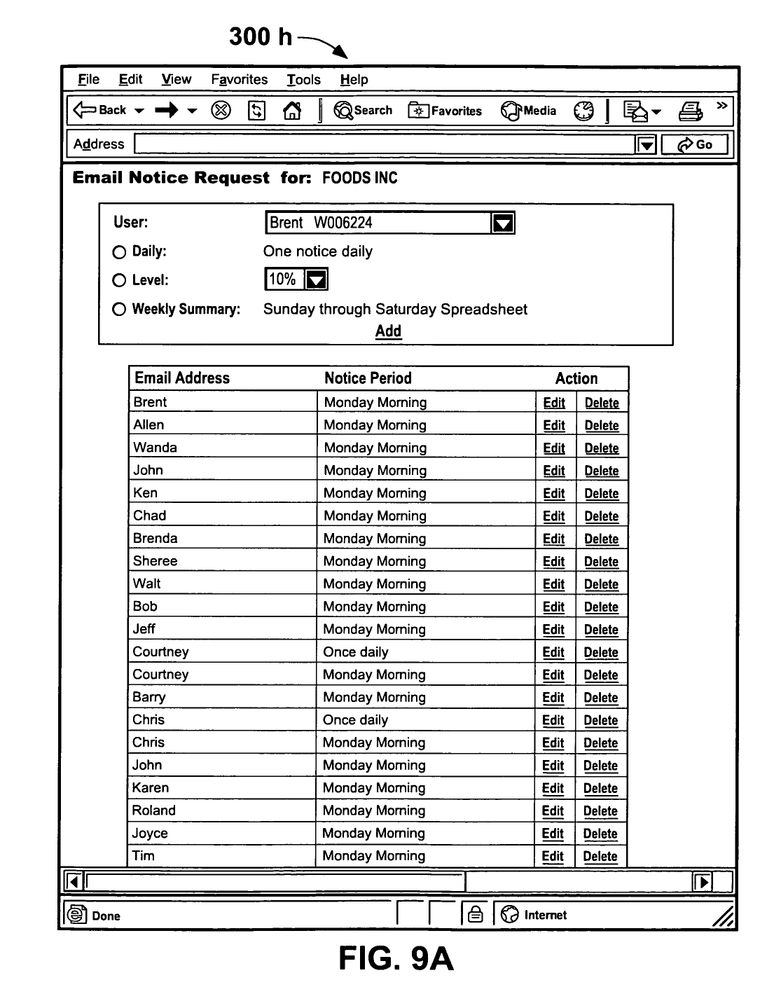

FIG. 9 illustrates an example web page 300g, according to various embodiments of the present invention, that is served when a user selects the “User Administration” tab 325 on web page 300a shown in FIG. 3. For security purposes, the web page 300g may feature a login screen that enables an authorized system administrator, for example, to access and write to administrative data fields. The data fields may control a user's permission to access information associated with specified locations 40, 42 and/or containers 12. In addition, the data fields may control a user's permission to view and/or write to system tabs 320-326 featured on web page 300a shown in FIG. 3. In certain embodiments, the web page 300g may include a listing of system users that identifies each user and the features of the inventory management system 10 that each user has permission to access. The listing may include, for example, a user name, an “admin” flag and/or an action feature that enables the system administrator to add, delete and/or edit the security status of various listed users.

FIG. 9A illustrates an example of a further web page 300h, according to the present embodiments, that is served when a user selects the “User Administration” tab 325 on web page 300a shown in FIG. 3. The web page 300h may, for example, enable a system administrator to assign a user the permission to receive weekly reports, daily reports, and/or email notifications as defined hereinabove with reference to FIGS. 4, 5 and 7. In various embodiments, the web page 300h may also include a listing of system users that identifies each user and defines the frequency with which each user is to receive reports and/or notifications. The listing may include, for example, the user name, e-mail address, notice period and/or an action feature that enables the system administrator to add, delete and/or edit the notice request status of the listed user.

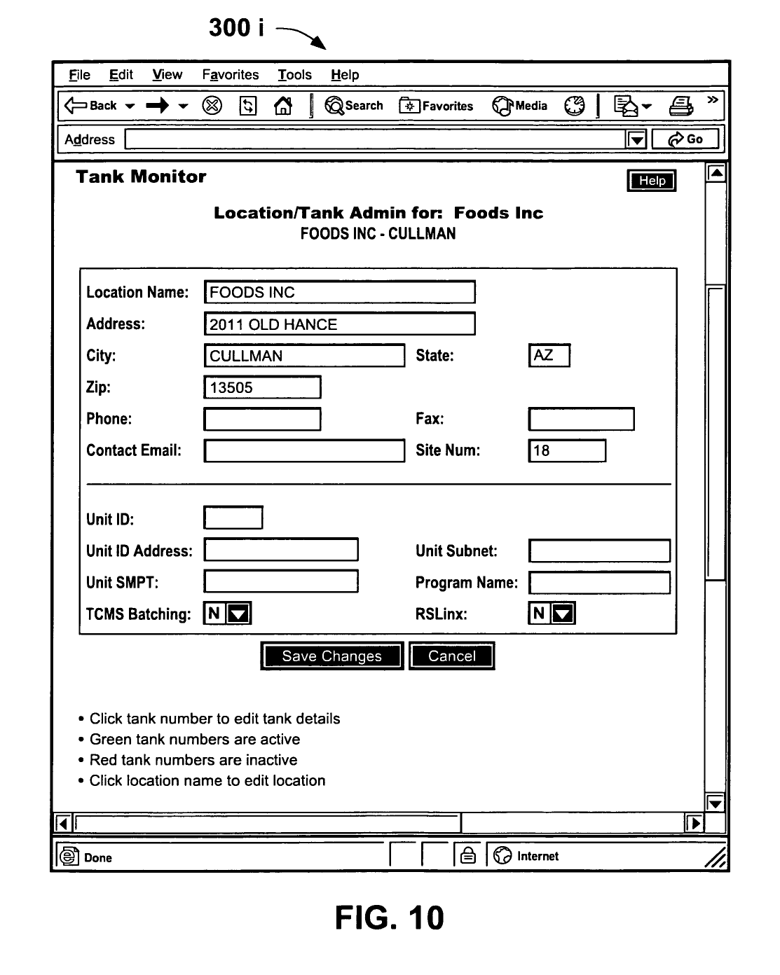

Referring now to FIG. 10, a sample web page 300i is structured in accordance with various embodiments of the present invention. The web page 300i is served when a user selects the “Tank/Location Administration” tab 326 on the web page 300a shown in FIG. 3. The web page 300i may enable a system administrator, for example, to update the inventory management system 10 by adding, deleting and/or updating a monitored location 40 and/or a container 12. In various embodiments, the web page 300i may include, for example, location data fields that enable a system administrator to enter location name, location address, location contact information, network settings, network address information and batching systems information for the monitored location 40. The web page 300i may also include one or more container 12 data fields that enable the system administrator to enter container dimensions, container location, sensor settings, telemetry settings and inventory information.

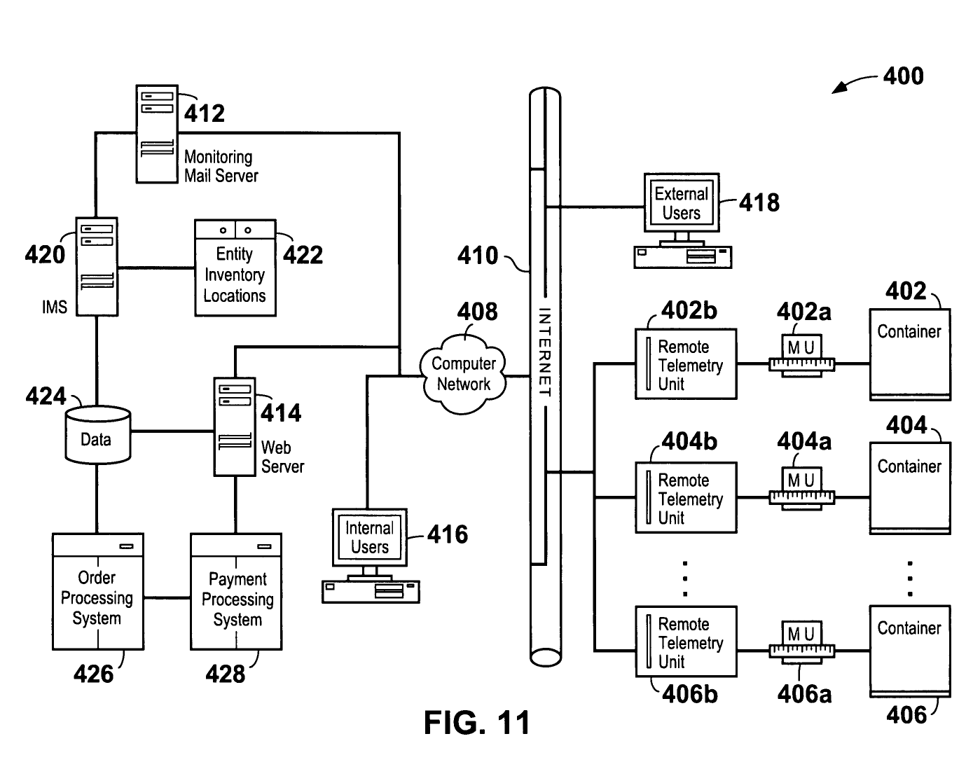

FIG. 11 schematically depicts an inventory management system 400 structured in accordance with various embodiments of the present invention. The inventory management system 400 may be configured to monitor and/or process inventory data associated with inventory material stored in one or more containers 402, 404, 406 at one or more monitored locations. Each container may have a measurement unit 402A, 404A, 406A operatively associated with a telemetry unit 402B, 404B, 406B configured for gathering inventory data related to the amount of inventory material stored in the containers 402, 404, 406. The measurement units 402A, 404A, 406A and telemetry units 402B, 404B, 406B may be structured or configured in substantial accordance with the previously discussed measurement unit and telemetry unit components (see above, e.g., discussion of FIGS. 1, 1A and 2).

The telemetry units 402B, 404B, 406B may be configured for data communication with a computer network 408 of an entity through a network connection 410 such as an Internet connection, for example. In various embodiments, the computer network 408 may be in operative communication with a monitoring mail server 412, a web server 414, and/or one or more internal users 416 of the inventory management system 400. Examples of internal users include, without limitation, sales personnel or engineering personnel of the entity that utilizes the inventory management system 400. In addition, one or more external users 418 may be provided with access to the inventory management system 400. Examples of external users 418 include, without limitation, customers that desire access to the inventory management system 400 to obtain inventory information.

It can be appreciated that the monitoring mail server 412 and the web server 414 may be configured to perform functions substantially similar to the functions performed by analogous components previously described herein (see above, e.g., discussion of FIGS. 1, 1A and 2). In various embodiments, the monitoring mail server 412 may be configured to store data, transmit data and/or receive data through its operative association with the telemetry units 402B, 404B, 406B and/or other components within the inventory management system 400. The monitoring mail server 412 may also be configured to generate, transmit and receive notifications, wherein the notifications may include, for example and without limitation, (1) delivery notifications that detail a supplier's promise date to deliver material, (2) inventory level notifications that communicate potential material “stock-outs” and/or (3) system alerts that inform customers and suppliers of network outages, measurement instrument loss, hardware/software issues or other system failures.

The telemetry units 402B, 404B, 406B may be in communication with their corresponding measurement instruments 402A, 404A, 406A via wireline and/or wireless communications links. In addition, the telemetry unit 16 may also be in communication with the network connection 410 via wireline and/or wireless communications links. A wireline communication link may be embodied as an Ethernet connection, for example, or other conventional twisted pair copper wirelines or coaxial cable connection. In various aspects, wireless communications links may be implemented using radio frequencies (RF) such as, for example, IEEE 802.11 wireless LAN or Bluetooth technologies.

According to various embodiments, the monitoring mail server 20 may be in operative communication with an inventory management server 420 located at a suitable inventory management location such as, for example, a customer workplace, supplier workplace, or container storage facility. In certain embodiments, the servers 412, 420 may transfer and/or receive data through one or more e-mail systems that are in communication with the inventory management system 400 through TCP/IP (Transmission Control Protocol/Internet Protocol) connections, for example. The servers 412, 420 may also be configured to transmit and/or receive inventory information and/or other data via an Advanced Intelligent Network (“AIN”). The inventory information and/or other data may be formatted in a File Transfer Protocol (“FTP”), wherein FTP may be employed when the telemetry units 402B, 404B, 406B, for example, may not be able to access the network connection 410. In certain embodiments, the inventory management server 420 may be configured to receive data in the form of a Universal Datagram Packet (“UDP”). For example, UDP may be employed to transfer container readings internally within a company via wireless Ethernet connection. The inventory management server 420 may be configured to transmit and receive inventory information and other data to/from the monitoring mail server 412.

In addition, the inventory management server 420 may receive inventory data or other data from one or more entity inventory locations 422 associated with the entity that supports the infrastructure for the inventory management server 400. The entity inventory locations 422 may be provided with suitable containers, measurement units, and/or telemetry units configured for operation substantially in accordance with the containers, measurement units and/or telemetry units previously described herein. It can be seen that having both customer monitored locations and the entity inventory locations 422 may provide an entity with an indication of its own inventory material levels (or its suppliers' inventory material levels), as well as the inventory material levels for customer locations.

The inventory management server 420 may be configured to transmit data to and/or receive data from the monitoring mail server 412 and/or other components of the inventory management system 400. The inventory management server 420 may also be configured to generate, transmit and receive notifications, wherein the notifications may include, for example and without limitation, (1) delivery notifications that detail a supplier's promise date to deliver material, (2) inventory level notifications that communicate potential material “stock-outs” and/or (3) system alerts that inform customers and suppliers of network outages, measurement instrument loss, hardware/software issues or other system failures.

In various embodiments, the inventory management server 420 may be configured to extract data from a communication sent from the monitoring mail server 412 and store the data in a suitable data storage medium such as a database 424, for example. The database 424 may be in operative communication with the web server 414 and/or an order processing system 426. Once data is extracted and transferred to the database 424 by the inventory management server 420, the web server 414 may access and display the data on an Internet website, for example, that may be made accessible to the internal users 416 or the external users 418. In certain aspects of the present invention, the web server 414 may be configured to transmit data to and/or receive data from the database 424 or the computer network 408. In addition, the web server 414 may be configured to generate, transmit and/or receive notifications, wherein the notifications may include, for example and without limitation, (1) delivery notifications that detail a supplier's promise date to deliver material, (2) inventory level notifications that communicate potential material “stock-outs” and/or (3) system alerts that inform customers and suppliers of network outages, measurement instrument loss, hardware/software issues or other system failures.

In various embodiments, at least one of the servers 412, 414, 420 may be based on Extensible Markup Language (“XML”), a computer language that encloses data in “documents” that are portable between/among software applications, wherein the data may include inventory information, notifications and/or other data utilized by the inventory management system 400. According to certain embodiments, XML may be utilized as a system-independent language for representing data that is transmitted throughout the inventory management system 400. This transmission of data may be in the form of simple object access protocol (“SOAP”) messages, which are XML-based messages that are communicated through standard Internet protocols such as, for example, Hypertext Transfer Protocol (“HTTP”) and Simple Mail Transfer Protocol (“SMTP”). In addition, communication of data through the inventory management system 400 may occur, for example, (1) at defined cycle times, (2) in real time and/or (3) be triggered by a customer, supplier or other user interacting with an Internet-accessible website that is supported by the web server 414, for example.

In various embodiments of the present invention, a payment processing system 428 may be configured for operative communication with one or both of the web server 414 and the order processing system 426. Based on inventory data and information processed by the inventory management system 400, for example, an order generated through use of the order processing system 426 may generate an invoice within the payment processing system 428 for remittance to a customer, for example.

The inventory management system 400 may be configured to calculate, based on a usage rate of inventory material and a predetermined order point, whether an order for additional inventory material should be placed to meet usage demands. The system 400 can calculate timing of a replenishment order based on factors including, for example, average daily usage, requested days of on-hand inventory, transit time, inventory material currently in transit, order size, current inventory and/or maximum container capacity. If the system 400 determines that an order is to be placed, a customer service representative of the entity maintaining the system 400 and/or a customer can be notified via e-mail, for example, of the need for the order. Order estimation can be added as a notice request function on a suitable administration screen to permit only predetermined users to receive the order notifications. In certain aspects, order estimation may take into account, for example, a projected usage of inventory material, a production schedule, and/or a historical usage rate for the inventory material. The inventory management system 400 may be configured to communicate with one or more external production systems or forecasting systems of a customer, for example.

In certain embodiments, the system 400 can be configured to spool an order automatically for upload into the order processing system 426, for example. The order information may be reviewed by a customer service representative or other user who can accept, reject or amend the order. Once a generated order has been reviewed and processed within the order processing system 426, the order information can be stored in a shipment information portion of the system 400 (e.g., in one or more data tables accessible by the inventory management server 420) for further action or processing. In certain aspects, order generation may take into account, for example, a calculated re-order point, projected usage of inventory material, a production schedule, and/or a historical usage rate for the inventory material. In association with order generation, the inventory management system 400 may be configured to communicate with one or more external production systems or forecasting systems of a customer, for example.

In various embodiments, the inventory management system 400 may be configured for data upload and integration of order information between the order processing system 426 and the inventory management server 420 through the database 424. Shipment information can be entered in the order processing system 426 for upload to one or more shipment entry tables in the inventory management server 420. Shipment information may include, for example, “sold to” data, “ship to” data, order numbers, product information, delivery dates, weight of inventory material, and/or load out information. It can be seen that because the order processing system 426 automatically feeds data to the inventory management server 420, the need for double entries of information and the associated possibility of data inconsistency for shipment information may be reduced.

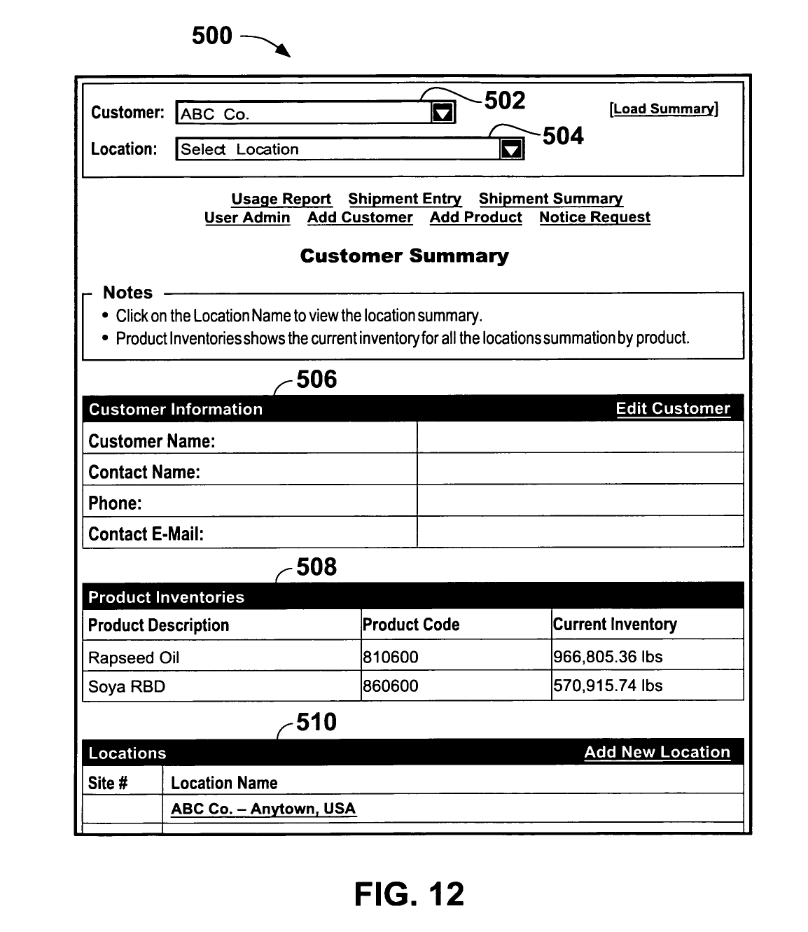

FIGS. 12 through 26 illustrate various examples of web page screen displays structured in accordance with various operational aspects of the present invention, wherein the web pages are supported by the web server 414, for example, and may be accessible by users through the computer network 408 or the network connection 410. The web server 414 may support a website that comprises one or more graphical user interfaces (GUIs) configured to receive and display user inputs and data as demonstrated by the examples presented in FIGS. 12 through 26.

Referring now to FIG. 12, a customer summary screen display 500 may be presented to a user of the inventory management systems described herein. As shown, the customer summary screen 500 permits selection of a customer designation 502 and a monitored location 504 associated with the customer. The customer summary screen 500 may also include a customer information section 506 having customer contact information, for example. In addition, a product inventories section 508 may include a listing of products stored at the monitored location 504 along with a total inventory material amount associated with each product at the monitored location 504. In addition, a locations section 510 may include a listing of all monitored locations associated with a particular customer. As shown, the locations section 510 may further include one or more links that guide a user to additional information for a particular monitored location or locations.

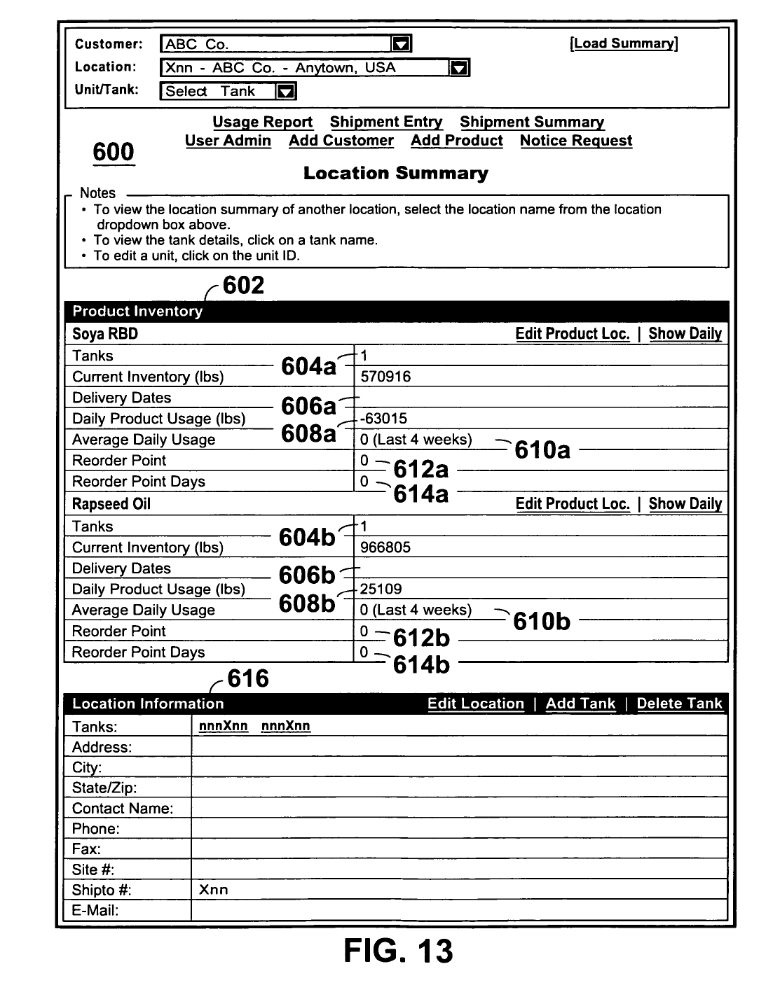

Referring now to FIG. 13, a location summary screen 600 may be presented to a user of the inventory management systems described herein. As shown, the location summary screen 600 provides a variety of information for a particular monitored location of a given customer. A product inventory section 602 may include inventory material data on a product-by-product basis for the containers used to store each product (containers are sometimes referred to herein as “tanks”). For each product, the screen 600 may display the number of tanks 604A, 604B used to store each product; any delivery dates 606A, 606B scheduled for delivery of replenishment inventory material; daily product usage data 608A, 608B; average daily usage data 610A, 610B; and/or reorder point data (expressed both as a quantity (e.g., pounds) or percentage 612A, 612B and as a number of reorder point days 614A, 614B). In addition, a location information section 616 may include data specific to the monitored location, as shown.

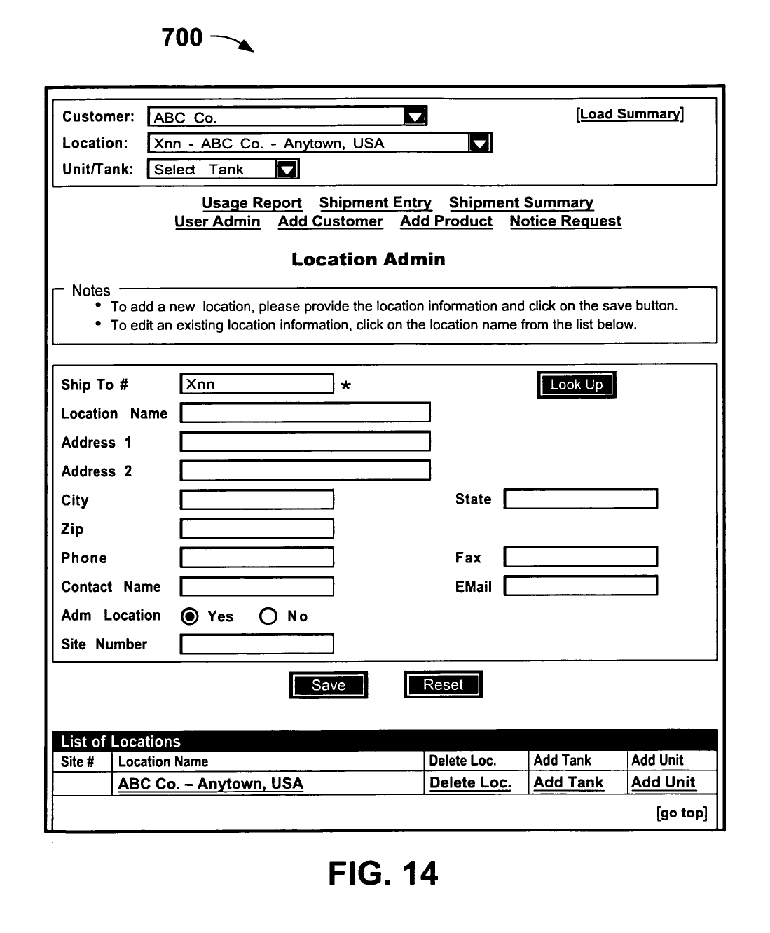

Referring now to FIG. 14, a location administration screen 700 is provided that can be used in connection with various aspects of the inventory management systems described herein. The location administration screen 700 can be employed to enter data for a given monitored location, as shown.

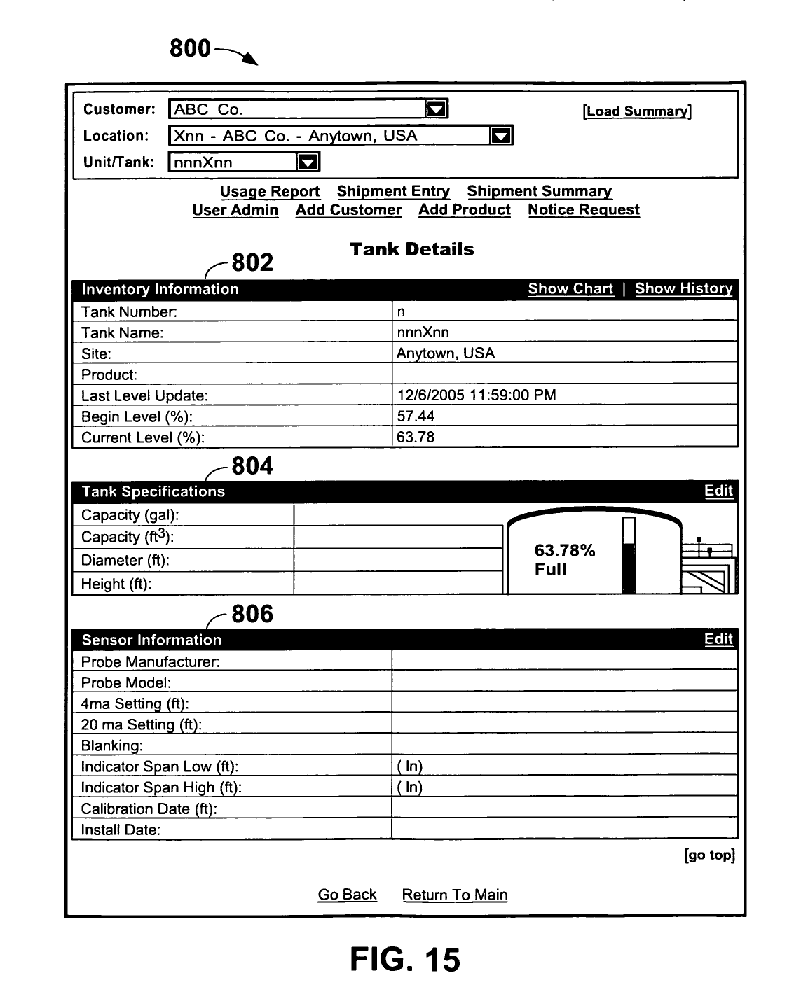

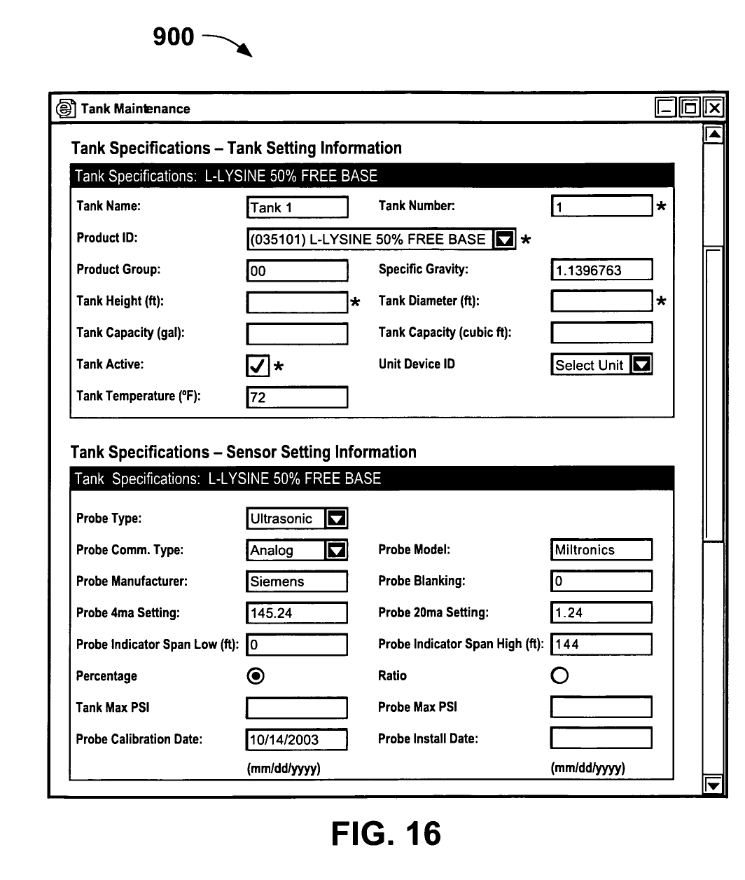

Referring now to FIG. 15, a tank details screen 800 is provided that can be used in connection with various aspects of the inventory management systems described herein. The tank details screen 800 includes an inventory information section 802 that includes inventory material information such as product type, beginning level data, current level data, and the most recent time when level data was updated. A tank specifications section 804 includes capacity and dimensional characteristics of the container. In addition, a sensor information section 806 includes settings for a sensor employed to monitor inventory material within the container. As shown in FIG. 16, a tank maintenance screen 900 permits an administrative user, for example, to modify tank specifications and/or sensor settings.

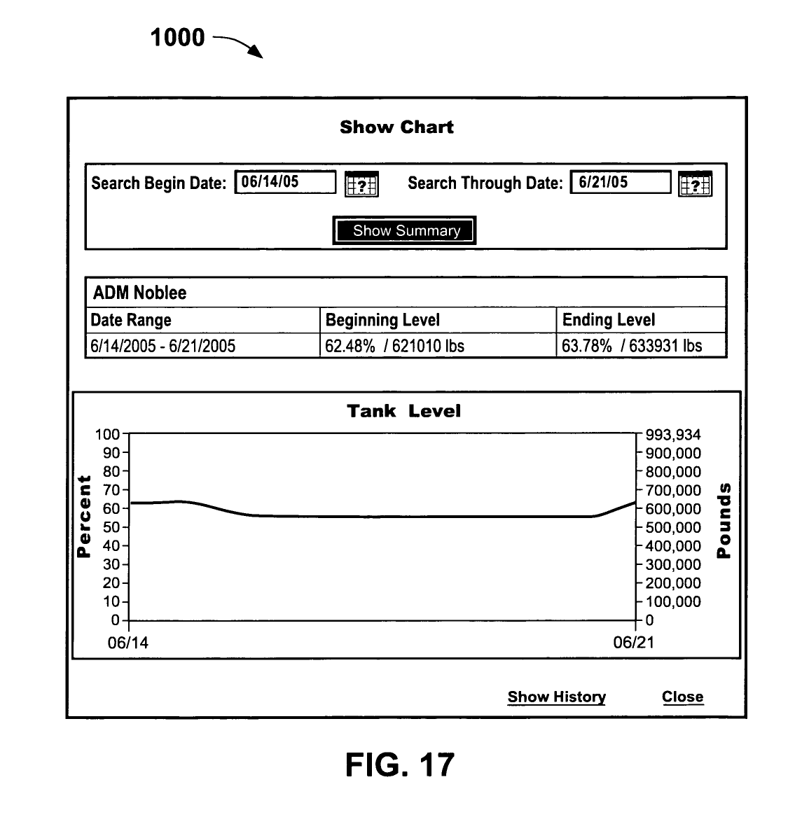

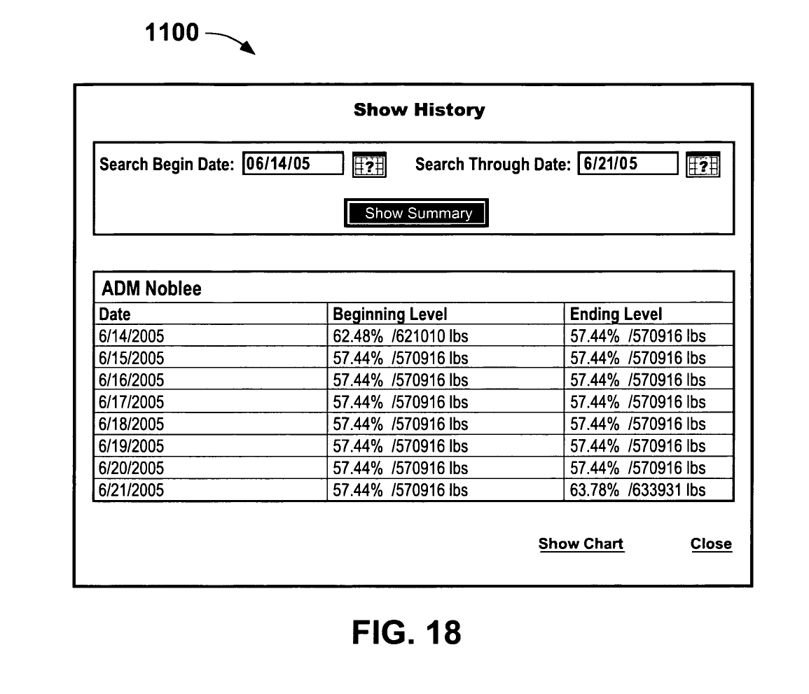

With reference to FIG. 17, a show chart screen display 1000 is provided for use in association with various aspects of the inventory management systems described herein. The show chart screen display 1000 provides a graphical representation of tank level for a user-specified period of time for a given container. As shown, the tank level can be expressed as one or both of a percentage of container level or a number of pounds of inventory material stored within the container. It can be appreciated that any date range can be entered for generating a chart that graphically presents a level of inventory material for the container. A show history screen 1100, as illustrated in FIG. 18, includes a tabulation of container level data over a specified range of dates.

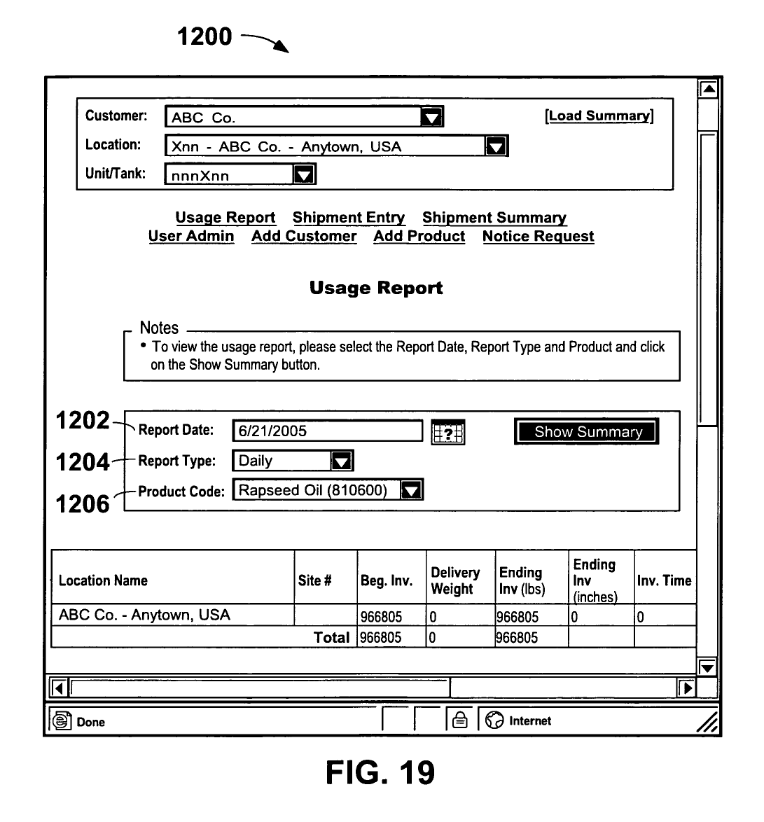

Referring now to FIG. 19, a usage report screen display 1200 can be provided in accordance with the various inventory management systems described herein. The usage report screen display 1200 permits a user to select, for a given customer and monitored location, to display usage of inventory material at the monitored location. As shown, a report date 1202, a report type 1204 (e.g., daily, weekly, monthly, or another suitable periodic), and a product code (i.e., for a particular inventory material type used at the monitored location) can be selected for generation of the report. The report date 1202 can be configured as a start date or an end date, as may be applicable or desired, based on the usage report desired by the user.

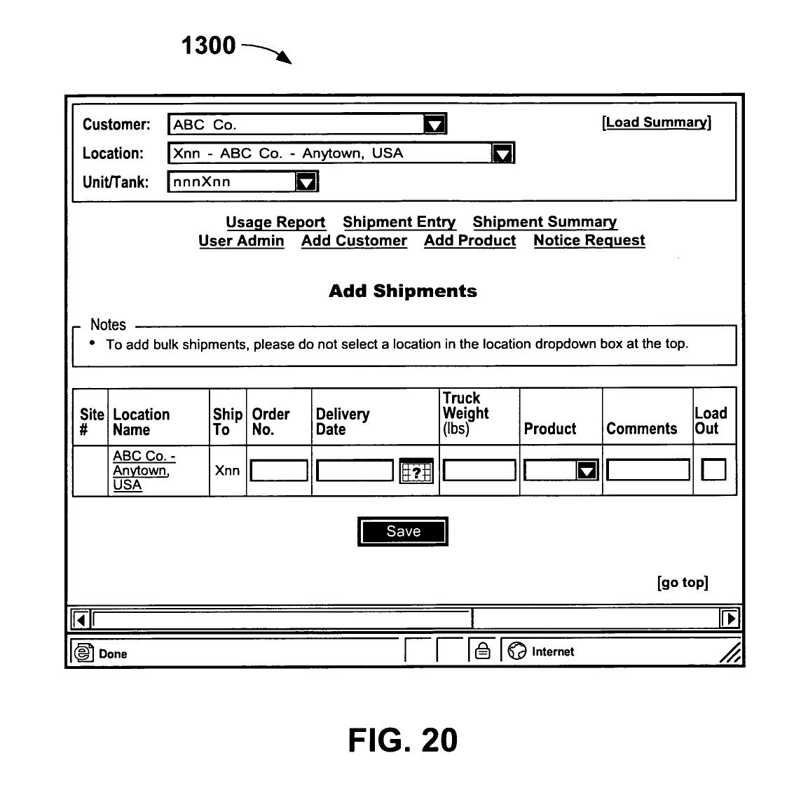

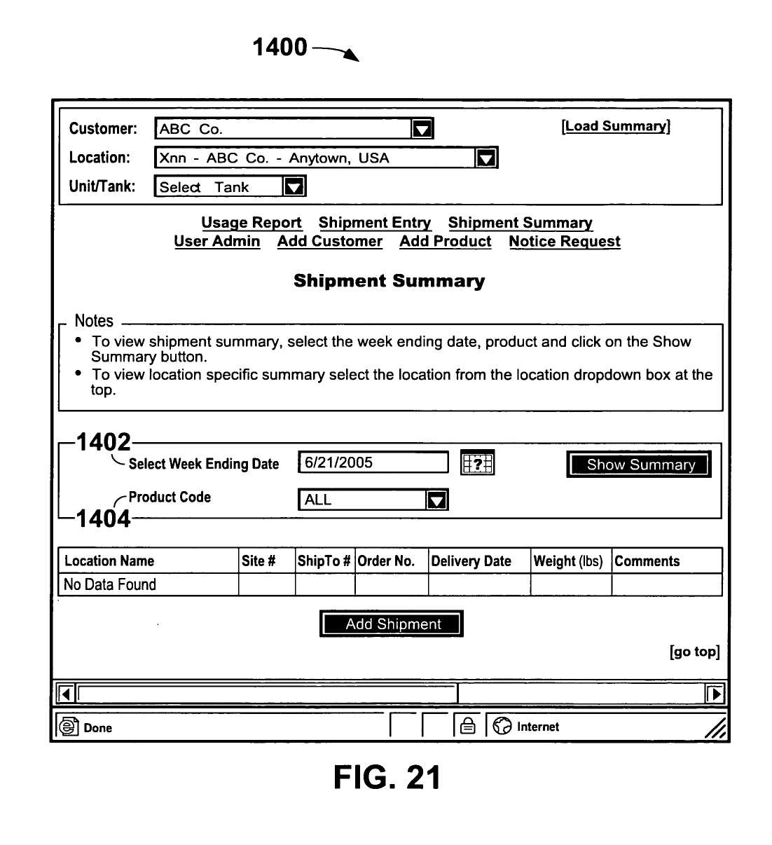

With reference to FIG. 20, a shipment entry screen 1300 can be provided for use in placing orders for replenishment inventory material in accordance with various embodiments of the present invention. As shown, the user can specify an order number, a delivery date, and an amount (in pounds) of a product type to be shipped to a selected customer at a monitored location or locations. A shipment summary screen 1400, as illustrated in FIG. 21, can be accessed to view prior or scheduled shipments of inventory to a customer at a monitored location or locations. A week ending date 1402 and a product code 1404 for the inventory material shipments may be designated in association with generating the shipment summary.

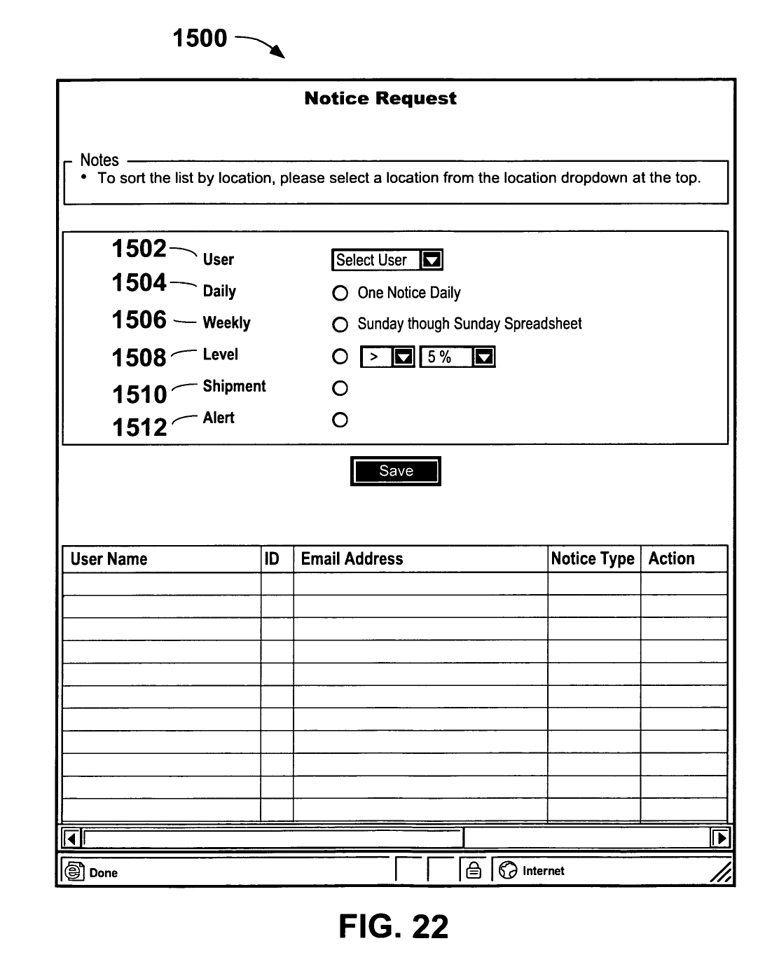

A notice request screen 1500, as shown in FIG. 22, permits an administrative user to designate various aspects of notifications (e.g., e-mail notifications) to be transmitted by the inventory management systems in connection with usage of inventory material at a monitored location. The notice request screen 1500 permits selection of a user/recipient 1502 of the notification, as well as selection of the frequency with which the notification is to be sent (e.g., daily 1504 or weekly 1506, as shown). The notification may also be sent at a predetermined level 1508 of the container is achieved, when a shipment 1510 of inventory material has occurred or will occur, and/or when an alert 1512 condition exists at a monitored location, such as when a telemetry unit, measurement unit or other component at the location experiences technical anomalies, for example.

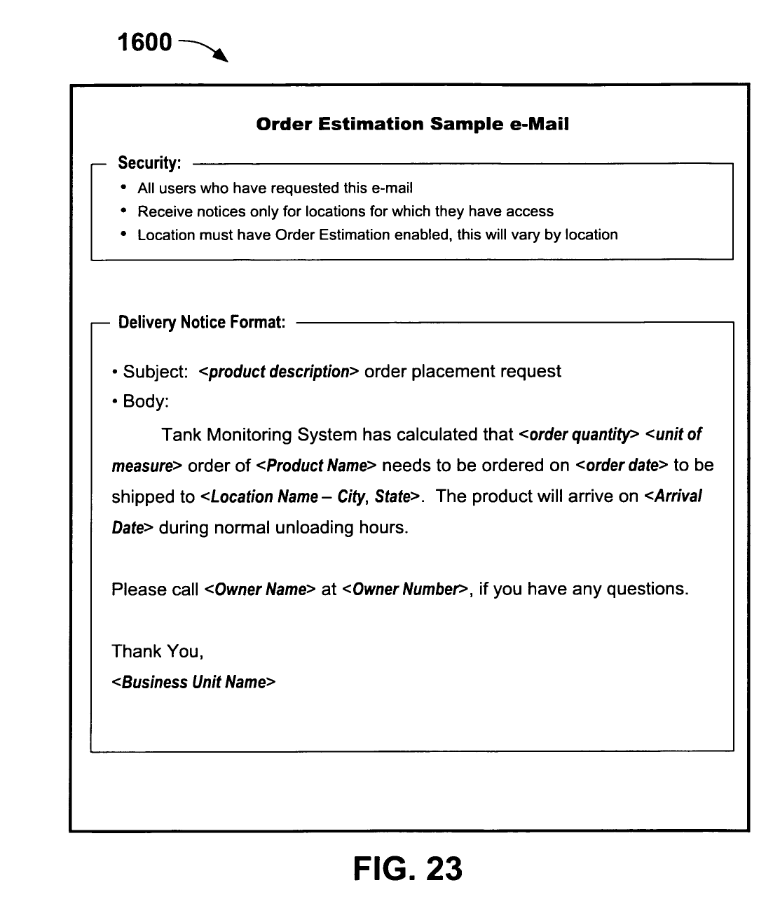

Referring now to FIG. 23, a sample e-mail notification 1600 is illustrated that can be transmitted to a recipient in accordance with various embodiments of the present inventory management systems. As shown, the e-mail notification 1600 can be generated and communicated in connection with various order estimation and/or generation functions described hereinabove. The e-mail notification 1600 may include information such as order quantity, product type for the inventory material, shipment destination, and/or arrival date for the shipment.

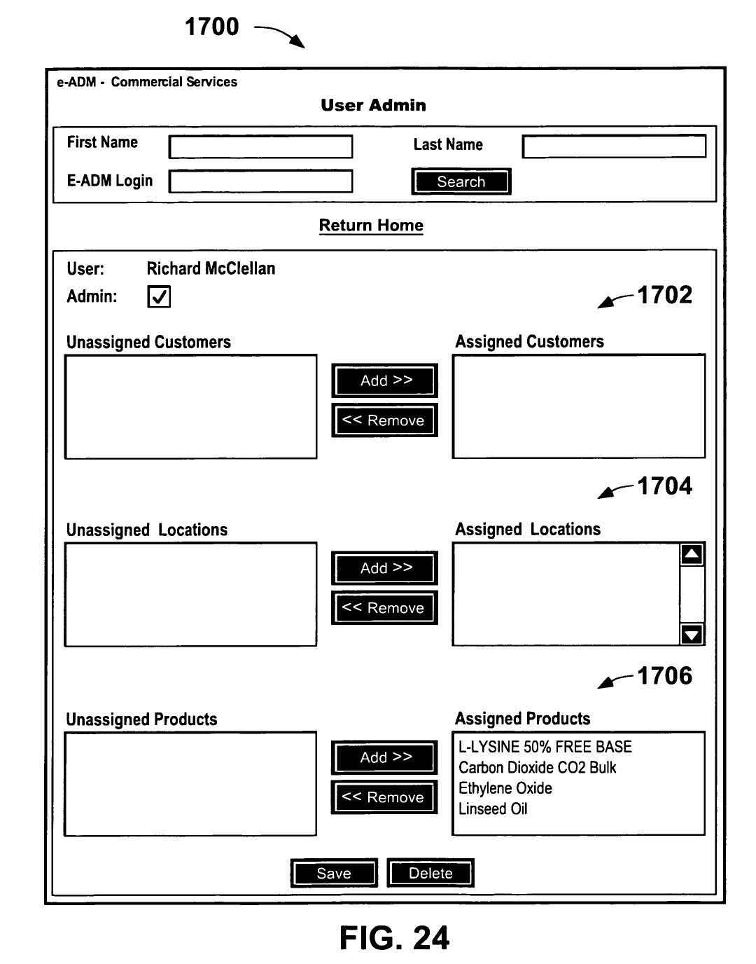

With reference to FIG. 24, a user administration screen 1700 may be accessed for setting permissions for various users of the inventory management systems described herein. The user administration screen 1700 includes a customers section 1702 for designating the particular customers that a user may access; a locations section 1704 for designating which monitored locations that a user may access; and a products section 1706 for designating which inventory materials that a user may access.

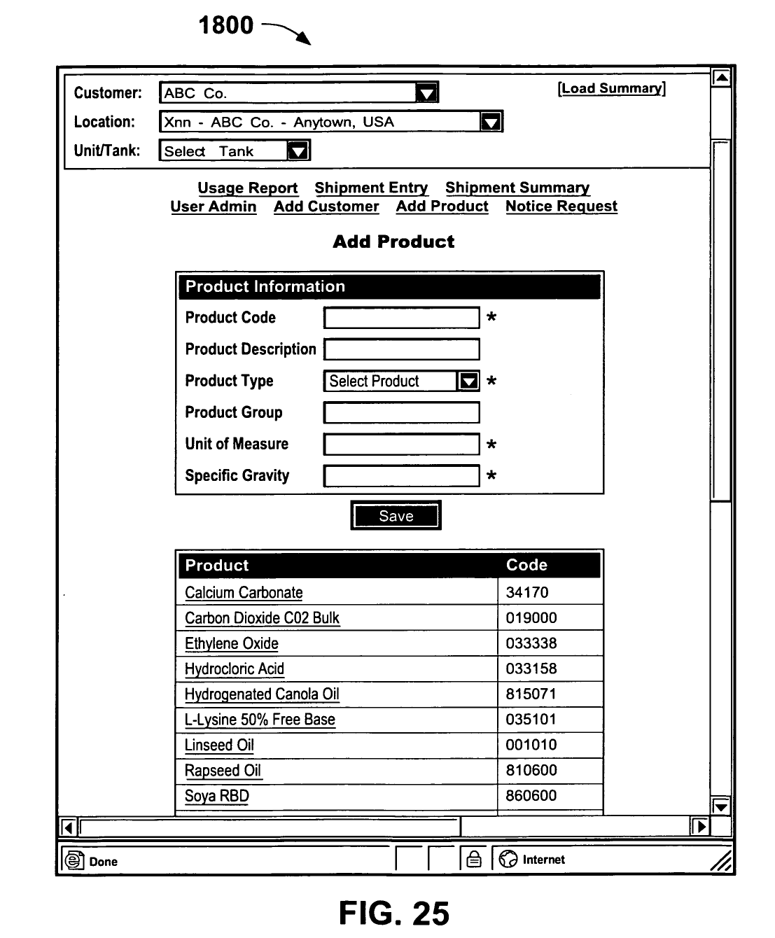

Referring now to FIG. 25, a product administration screen 1800 is provided to add products (i.e., inventory materials) to the various inventory management systems described herein. As shown, product characteristics such as product code, product description, product group, unit of measure, and specific gravity data may be entered for a particular inventory material.

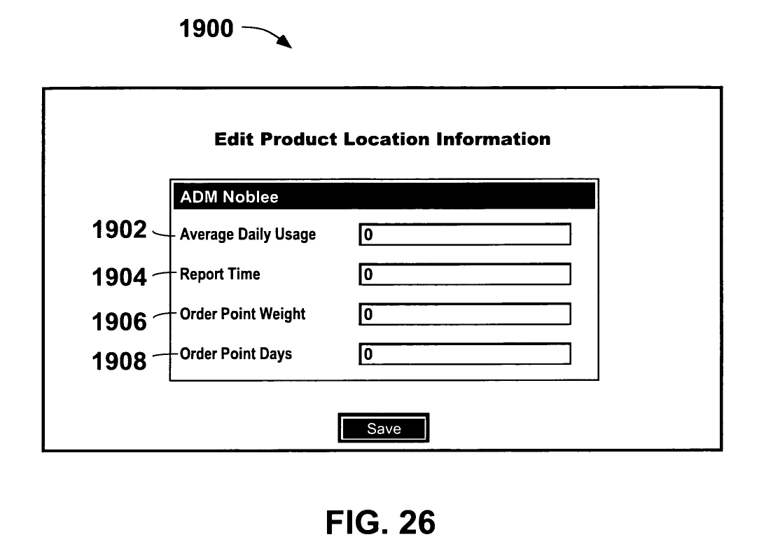

Referring now to FIG. 26, an edit product location information screen 1900 may be provided in accordance with various embodiments of the present inventory management systems. As shown, the edit product location information screen 1900 includes fields for entering data for inventory material for a given monitored location. The fields include average daily usage 1902, report time 1904 (e.g., the timing of communication of inventory information to an inventory management server), order point weight (e.g., pounds) 1906, and order point days 1908. The data supplied on this screen 1900 may be employed, for example, in association with the order estimation or order generation functions described hereinabove.

It is to be understood that the figures and descriptions of the present invention have been simplified to illustrate elements that are relevant for a clear understanding of the present invention, while eliminating, for purposes of clarity, other elements of a conventional inventory management system. For example, certain inventory operating system details and modules of network platforms are not described herein. Those of ordinary skill in the art will recognize, however, that these and other elements may be desirable in a typical inventory management system. However, because such elements are well known in the art and because they do not facilitate a better understanding of the present invention, a discussion of such elements is not provided herein.

Also, in the claims appended hereto, any element expressed as a means for performing a specified function is to encompass any way of performing that function including, for example, a combination of elements that perform that function. Furthermore the invention, as defined by such means-plus-function claims, resides in the fact that the functionalities provided by the various recited means are combined and brought together in a manner as defined by the appended claims. Therefore, any means that can provide such functionalities may be considered equivalents to the means shown herein.

In general, it will be apparent to one of ordinary skill in the art that some of the embodiments as described hereinabove may be implemented in many different embodiments of software, firmware, and hardware in the entities illustrated in the figures. The actual software code or specialized control hardware used to implement some of the present embodiments is not limiting of the present invention. For example, the embodiments described hereinabove may be implemented in computer software using any suitable computer software language type such as, for example, C or C++ using, for example, conventional or object-oriented techniques. Such software may be stored on any type of suitable computer-readable medium or media such as, for example, a magnetic or optical storage medium. Thus, the operation and behavior of the embodiments are described without specific reference to the actual software code or specialized hardware components. The absence of such specific references is feasible because it is clearly understood that artisans of ordinary skill would be able to design software and control hardware to implement the embodiments of the present invention based on the description herein with only a reasonable effort and without undue experimentation.

Moreover, the processes associated with the present embodiments may be executed by programmable equipment, such as computers. Software that may cause programmable equipment to execute the processes may be stored in any storage device, such as, for example, a computer system (non-volatile) memory, an optical disk, magnetic tape, or magnetic disk. Furthermore, some of the processes may be programmed when the computer system is manufactured or via a computer-readable medium. Such a medium may include any of the forms listed above with respect to storage devices and may further include, for example, a carrier wave modulated, or otherwise manipulated, to convey instructions that may be read, demodulated/decoded and executed by a computer.

It can also be appreciated that some process aspects described herein may be performed using instructions stored on a computer-readable medium or media that direct a computer system to perform the process aspects. A computer-readable medium may include, for example, memory devices such as diskettes, compact discs of both read-only and read/write varieties, optical disk drives, and hard disk drives. A computer-readable medium may also include memory storage that may be physical, virtual, permanent, temporary, semi-permanent and/or semi-temporary. A computer-readable medium may further include one or more data signals transmitted on one or more carrier waves.

A “computer” or “computer system” may be, for example, a wireless or wireline variety of a microcomputer, minicomputer, server, mainframe, laptop, personal data assistant (PDA), wireless e-mail device (e.g., BlackBerry), cellular phone, pager, processor, fax machine, scanner, or any other programmable device configured to transmit and receive data over a network. Computer devices disclosed herein may include memory for storing certain software applications used in obtaining, processing and communicating data. It can be appreciated that such memory may be internal or external to the disclosed embodiments. The memory may also include any means for storing software, including a hard disk, an optical disk, floppy disk, ROM (read only memory), RAM (random access memory), PROM (programmable ROM), EEPROM (electrically erasable PROM), and other computer-readable media.

In various embodiments of the present invention disclosed herein, a single component may be replaced by multiple components, and multiple components may be replaced by a single component, to perform a given function or functions. Except where such substitution would not be operative to practice embodiments of the present invention, such substitution is within the scope of the present invention. Any of the servers described herein, for example, may be replaced by a “server farm” or other grouping of networked servers that are located and configured for cooperative functions. It can be appreciated that a server farm may serve to distribute workload between/among individual components of the farm and may expedite computing processes by harnessing the collective and cooperative power of multiple servers. Such server farms may employ load-balancing software that accomplishes tasks such as, for example, tracking demand for processing power from different machines, prioritizing and scheduling tasks based on network demand, and/or providing backup contingency in the event of component failure or reduction in operability.

It can be appreciated that the various embodiments of the inventory management systems described herein can be readily modified for use with a variety of different languages, nomenclatures, units of measure, data security requirements, privacy requirements, and/or other similarly jurisdictionally or geographically dependent requirements. For example, modifications to inventory management system server architecture or database configurations that may be deemed necessary to fulfill data security or data privacy requirements in a certain country, region or jurisdiction are within the scope of the present invention.

While several embodiments of the invention have been described, it should be apparent, however, that various modifications, alterations and adaptations to those embodiments may occur to persons skilled in the art with the attainment of some or all of the advantages of the present invention. The disclosed embodiments are therefore intended to include all such modifications, alterations and adaptations without departing from the scope and spirit of the present invention as defined by the appended claims.

What is claimed is:

1. An inventory management system configured for use in association with at least one container containing an amount of inventory material at a monitored location, said system comprising:
at least one measurement instrument operatively associated with said container, said measurement instrument being configured to generate at least one data signal representative of said amount of said inventory material in said container;
a telemetry unit in communication with said measurement instrument, said telemetry unit being configured to receive at least said generated data signal from said measurement instrument and to convert said generated data signal into inventory information;
a first server in communication with said telemetry unit via an Internet connection, said first server configured to receive at least said inventory information from said telemetry unit; and,
at least a second server in communication with said first server, said second server configured for receiving at least said inventory information from said first server into at least one data storage medium operatively associated with said second server to process said inventory information for presentation on at least one website.

2. The system of claim 1, wherein said first server includes a monitoring mail server.

3. The system of claim 1, wherein said second server includes an inventory management server.

4. The system of claim 1, further comprising at least one web server in operative association with at least one of said servers.

5. The system of claim 4, further comprising said web server being configured to display at least one customer summary screen including a product inventories section having for a customer at least one of a listing of products stored at said monitored location, a total inventory material amount associated with each said product at said monitored location, and a listing of said monitored locations associated with said customer.

6. The system of claim 4, further comprising said web server being configured to display at least one location summary screen including for said monitored location a product inventory section having inventory material data displayed on a product-by-product basis for said containers at said monitored location.

7. The system of claim 6, wherein said location summary screen further includes at least one of a number of tanks, a delivery date, daily product usage data, average daily usage data, and reorder point data.

8. The system of claim 3, further comprising an order processing system in operative association with said inventory management server.

9. The system of claim 8, further comprising a payment processing system in operative association with at least one of said order processing system and a web server.

10. The system of claim 3, further comprising said inventory management system being configured to calculate whether an order for additional said inventory material should be placed for said monitored location.

11. The system of claim 10, wherein said order calculation is based on at least one factor selected from the group consisting of a usage rate of said inventory material and a predetermined order point.

12. The system of claim 1, further comprising said inventory management server being configured for generating at least one notification in association with said inventory information.

13. The system of claim 1, further comprising said inventory management server being configured for generating at least one notification in association with at least one order estimation based on said inventory information.

14. The system of claim 1, further comprising said inventory management server being configured to generate automatically an order for additional said inventory material.

15. The system of claim 14, wherein said order generation is based on at least one factor selected from the group consisting of a calculated re-order point, a projected usage of said inventory material, a production schedule, and a historical usage rate for said inventory material.
